(19) United States
(12) Patent Application Publication
(10) Pub. No.: US 2017/0053172 A1
(43) Pub. Date: Feb. 23, 2017

(54) IMAGE PROCESSING APPARATUS, AND IMAGE PROCESSING METHOD

(71) Applicant: Kabushiki Kaisha Toshiba, Minato-ku Tokyo (JP)

(72) Inventors: Toshiaki NAKASU, Shinagawa Tokyo (JP); Quoc viet PHAM, Yokohama Kanagawa (JP); Tomoki WATANABE, Inagi Tokyo (JP); Tomokazu KAWAHARA, Yokohama Kanagawa (JP); Yuto YAMAJI, Kawasaki Kanagawa (JP); Yusuke TAZOE, Kawasaki Kanagawa (JP); Osamu YAMAGUCHI, Yokohama Kanagawa (JP)

(21) Appl. No.: 15/239,130

(22) Filed: Aug. 17, 2016

(30) Foreign Application Priority Data
Aug. 20, 2015 (JP) 2015-163011
Mar. 22, 2016 (JP) 2016-057039

(51) Int. Cl. G06K 9/00; G06K 9/32; G06T 7/20

(52) U.S. Cl. CPC G06K 9/00778; G06T 7/2033; G06K 9/3241; G06T 2207/30196

(57) ABSTRACT

According to an embodiment, an image processing apparatus includes a hardware processor. The hardware processor is configured to acquire an image; calculate a density of an object captured in a region obtained by dividing the image; calculate a first density relative value of the region to a surrounding region which is surrounding the region; and detect an attention region out of the regions included in the image according to the first density relative value.

### CROSS-REFERENCE TO RELATED APPLICATIONS

This application is based upon and claims the benefit of priority from Japanese Patent Application No. 2015-163011, filed on Aug. 20, 2015, and Japanese Patent Application No. 2016-057039, filed on Mar. 22, 2016; the entire contents of which are incorporated herein by reference.

### FIELD

Embodiments described herein relate generally to an image processing apparatus and method.

### BACKGROUND

Techniques have been disclosed that estimate densities of objects captured in an image. Techniques have been disclosed that estimate the concentration degrees of objects and detect a region in which the concentration degree differs from a reference concentration degree by equal to or larger than a threshold as an attention region to which close attention should be paid in an image.

In the conventional techniques, however, the whole region is detected as the attention region when the density of the objects differs from a reference density by equal to or larger than a threshold overall in an image. It is, thus, difficult for the conventional techniques to accurately detect the attention region in the image.

### BRIEF DESCRIPTION OF THE DRAWINGS

FIG. 1 is a block diagram illustrating an image processing apparatus;

FIGS. 2A and 2B are schematic diagrams illustrating an example of an image;

FIGS. 3A to 3E are schematic diagrams illustrating a flow of processing performed on the image;

FIGS. 4A and 4B are explanatory views illustrating examples of calculation of a first density relative value;

FIG. 5 is an explanatory view of the calculation of the first density relative value using a weighted average;

FIG. 6 is another explanatory view of the calculation of the first density relative value using the weighted average;

FIGS. 7A to 7D are schematic diagrams illustrating examples of a display image;

FIG. 8 is a flowchart illustrating a procedure of the image processing;

FIG. 9 is a block diagram illustrating a first computation unit;

FIGS. 10A and 10B are explanatory views of calculation of a density of the objects;

FIG. 11 is a flowchart illustrating an exemplary procedure of the image processing;

FIG. 12 is a flowchart illustrating another exemplary procedure of the image processing;

FIG. 13A is a schematic diagram illustrating an example of flows of persons;

FIG. 13B is a schematic diagram illustrating an example of a display image;

FIGS. 14A to 14C are explanatory views of detection of the attention region;

FIG. 15 is a block diagram illustrating another image processing apparatus;

FIGS. 16A to 16I are schematic diagrams illustrating a flow of processing performed on the image;

FIG. 17 is a flowchart illustrating an exemplary procedure of the image processing;

FIG. 18 is a block diagram illustrating another functional structure of the first computation unit;

FIGS. 19A and 19B are schematic diagrams illustrating another example of the image;

FIGS. 20A to 20D are schematic diagrams illustrating processing performed on the image;

FIG. 21 is an explanatory view of calculation of likelihood;

FIGS. 22A to 22C are explanatory views of production of density data;

FIG. 23 is a flowchart illustrating a flow of processing to produce the density data;

FIG. 24 is a block diagram illustrating an exemplary structure of a fourth computation unit;

FIGS. 25A to 25C are explanatory views of pre-processing;

FIGS. 26A to 26D are explanatory views of a correction image, a partial image, and a label;

FIG. 27 is a block diagram illustrating an exemplary structure of a second calculator;

FIG. 28 is an explanatory view of the label and a histogram;

FIG. 29 is an explanatory view of a voting histogram;

FIG. 30 is an explanatory view of a random tree;

FIG. 31 is an explanatory view of a random forest;

FIG. 32 is an explanatory view of prediction of a representative label;

FIG. 33 is the explanatory view of the random tree;

FIG. 34 is the explanatory view of prediction of the representative label;

FIG. 35 is a flowchart illustrating a procedure of provisional density calculation processing;

FIG. 36 is a flowchart illustrating a procedure of the calculation illustrated in FIG. 35; and

FIG. 37 is a block diagram illustrating an exemplary hardware structure.

### DETAILED DESCRIPTION

According to an embodiment, an image processing apparatus includes a hardware processor. The hardware processor is configured to acquire an image; calculate, a density of an object captured in the region obtained by dividing the image; calculate a first density relative value of the region to a surrounding region which is surrounding the region; and detect an attention region out of the regions included in the image according to the first density relative value.

Embodiments will be described in detail with reference to the accompanying drawings.

### First Embodiment

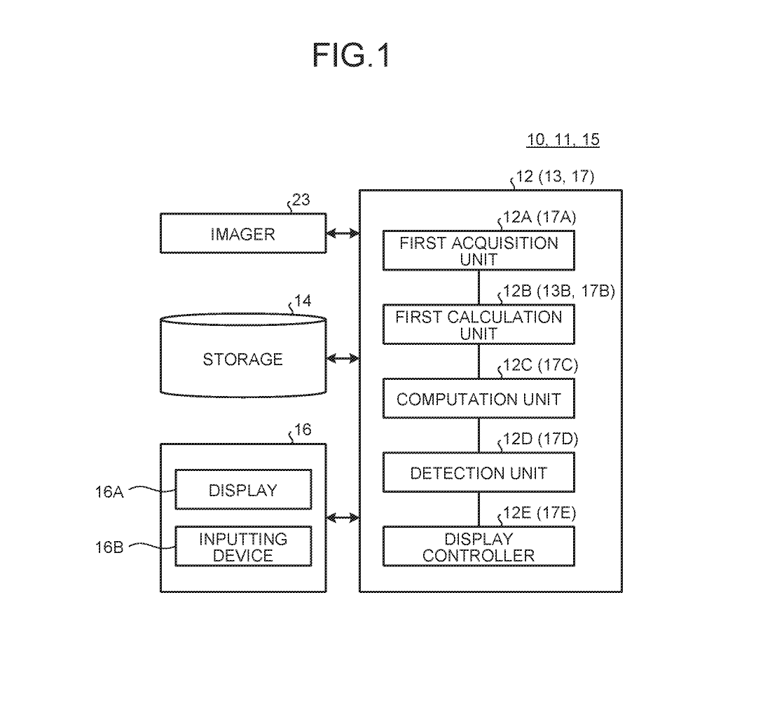

FIG. 1 is a block diagram illustrating an image processing apparatus 10 according to a first embodiment.

The image processing apparatus 10 detects an attention region using a density of objects captured in an image. The attention region is a region to which a user is prompted to pay attention. In the first embodiment, it is assumed that the attention region is a region having a different feature from those of other regions, which is determined by the density of the objects. The objects are imaged and identified by analyzing the taken image. In the embodiment, a person is an example of the object.

The image processing apparatus 10 includes a controller 12, a storage 14, a UI (user interface) 16, and an imager 23. The storage 14, the UI unit 16, and the imager 23 are electrically connected to the controller 12.

The UI unit 16 has a display function to display various images and an input function to receive various operation instructions from a user. In the embodiment, the UI unit 16 includes a display 16A and an inputting device 16B. The display 16A displays various images. The display 16A is a cathode-ray tube (CRT) display, a liquid crystal display, an organic electroluminescent (EL) display, or a plasma display, for example. The inputting device 16B receives the user's various instructions and information input. The inputting device 16B is a keyboard, a mouse, a switch, or a microphone, for example.

The UT unit 16 may be a touch panel in which the display 16A and the inputting device 16B are integrated.

The imager 23 obtains an image by performing photographing. In the embodiment, the imager 23 photographs a region or a subject, which is a target for detecting the attention region, in a real space, and obtains an image.

The imager 23 is a digital camera, for example. The imager 23 may be disposed apart from the controller 12. The imager 23 is a security camera placed on a road, in a public space, or in a building, for example. The imager 23 may be an on-vehicle camera placed in a moving body such as a vehicle or a camera built in a mobile terminal. The imager 23 may be a wearable camera.

The imager 23 is not limited to a visible light camera that images an object using reflected light in a visible wavelength from the object. For example, the imager 23 may be an infrared camera, a camera capable of acquiring a depth map, or a camera that images an object using a distance sensor or an ultrasonic sensor.

In short, the image of the target for detecting the attention region according to the embodiment is not limited to a specific image. Examples of the image of the target include a taken image using reflected light in a visible wavelength, an infrared image, a depth map, and a taken image using ultrasonic.

The storage 14 stores therein various types of data. In the embodiment, the storage 14 stores therein the image of the target for detecting the attention region. The storage 14 is implemented by at least one of storage devices capable of magnetically, optically, or electrically storing data, such as a hard disk drive (HDD), a solid state drive (SSD), a read only memory (ROM), and a memory card.

The controller 12 is a computer that includes a central processing unit (CPU), a ROM, and a random access memory (RAM), for example. The controller 12 may be a circuit other than the CPU.

The controller 12 controls the whole of the image processing apparatus 10. The controller 12 includes a first acquisition unit 12A, a first calculation unit 12B, a computation unit 12C, a detection unit 12D, and a display controller 12E.

A part or the whole of the first acquisition unit 12A, the first calculation unit 12B, the computation unit 12C, the detection unit 12D, and the display controller 12E may be implemented by causing a processing unit such as a CPU to execute a program, that is, by software, hardware such as an integrated circuit (IC), or by both of software and hardware.

The controller 12 may be provided with at least the first acquisition unit 12A, the first calculation unit 12B, the computation unit 12C, and the detection unit 12D. The controller 12 may not include the display controller 12E.

The first acquisition unit 12A acquires the image of the target for detecting the attention region. In the embodiment, the first acquisition unit 12A acquires the image from the imager 23. The first acquisition unit 12A may acquire the image from an external device (not illustrated) or the storage 14, for example.

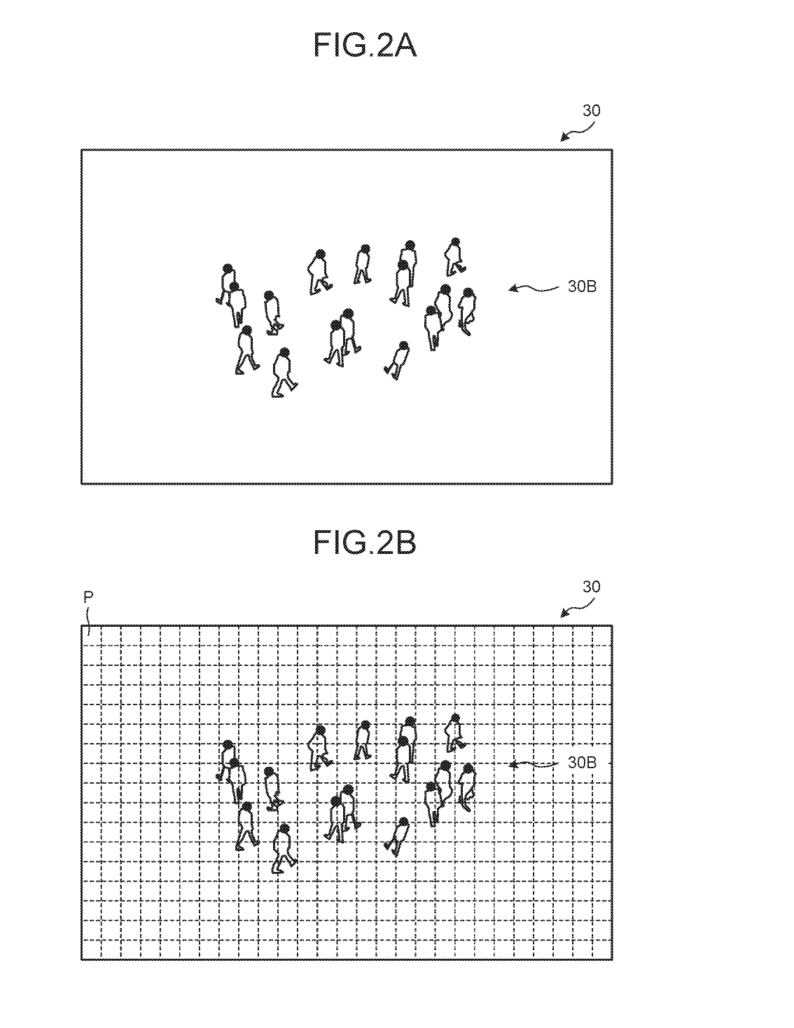

FIGS. 2A and 2B are schematic diagrams illustrating an example of an image 30, which is the target for detecting the attention region. In the embodiment, the image 30 includes a plurality of persons 30B as the objects (refer to FIG. 2A).

Referring back to FIG. 1, the first calculation unit 12B calculates, for each of a plurality of regions obtained by dividing the image acquired by the first acquisition unit 12A, a density of the persons 30B captured in the region.

FIG. 2B is a schematic diagram illustrating a plurality of regions P obtained by dividing the image 30. The first calculation unit 12B divides the image 30 into the multiple regions P. The number of regions obtained by dividing the image 30 and the size of the region P can be set to any values.

Each region P may be a region obtained by dividing the image 30 into a matrix of M×N pieces. M and N are integers equal to or larger than one, and at least one of M and N is an integer more than one.

The region P may be a region divided as a region composed of a group of pixels having at least one of similar luminance and a similar color out of the pixels included in the image 30. The region P may be a region obtained by dividing the image 30 in accordance with a predetermined attribute. The attribute is a region that indicates a specific object to be imaged in the image 30. Examples of the attribute include a region indicating a crosswalk, a region indicating a left traffic lane, a region indicating an off-limits region, and a dangerous region.

Alternatively, the region P may be a pixel region that includes a plurality of pixels or only a single pixel. When the size of the region P is closer to a size equivalent to the size of a single pixel, the image processing apparatus 10 can calculate the density more accurately. The region P, thus, preferably has a size equivalent to the size of a single pixel. However, as described above, the region P may include a plurality of pixels.

The first calculation unit 12B preliminarily stores therein a division condition of the region P, for example. Examples of the division condition include a division in a matrix of M×N, a division in accordance with luminance and a color, and a division in accordance with the attribute.

The first calculation unit 12B divides the image 30 into the multiple regions P in accordance with the preliminarily stored division condition. The division condition may be appropriately changeable by the user's instruction through the inputting device 16B, for example.

For example, when dividing the image 30 in accordance with the attribute, the first calculation unit 12B preliminarily performs machine learning on correct answer data to which the attribute is imparted using a feature amount of the image 30 to produce a discriminator. The first calculation unit 12B divides the image 30 into the multiple regions P in accordance with the attribute using the discriminator. For another example, when dividing the image 30 in accordance with the attribute indicating a dangerous region, the first calculation unit 12B preliminarily prepares map data indicating a plurality of dangerous regions, and then divides the image 30 into regions corresponding to the dangerous regions in the map data and the other regions corresponding to the other regions excluding the dangerous regions in the map data. Alternatively, the first calculation unit 12B may divide the image 30 into the multiple regions P in accordance with boundary lines instructed by the user through the UI unit 16.

In the embodiment, the description is given for a case in which the first calculation unit 12B divides the image 30 into a matrix of M×N pieces, as an example.

The first calculation unit 12B calculates, for each region P in the image 30, the density of the objects captured in the region P. In the embodiment, the first calculation unit 12B calculates, for each region P, the density of the persons 30B captured in the region P.

The following describes an exemplary method for calculating the density of the persons 30B captured in each region P.

The first calculation unit 12B counts the number of persons 30B in each region P using a known method. When a part of the body of the person 30B is captured in the region P, a result of dividing the area of the part captured in the region P of the person 30B by the area of the person 30B may be used as the count. For example, when 50% of the body of the person 30B is captured in the region P, the person 30B may be counted as 0.5 persons.

The first calculation unit 12B may calculate, for each region P, as the density of the persons 30 in the region P, a value obtained by dividing the number of persons 30B captured in the region P by the area of the region P. Alternatively, the first calculation unit 12B may calculate, for each region P, as the density of the persons 30 in the region P, a value obtained by dividing the number of persons 30B captured in the region P by the number of pixels included in the region P.

Alternatively, the first calculation unit 12B may calculate, for each region P, a dispersion degree of the persons 30B in the region P as the density of the persons 30 in the region P. For example, the first calculation unit 12B calculates the positions of the persons 30B in the region P for each of a plurality of sub-regions (e.g., pixels) obtained by dividing the region P. The first calculation unit 12B may calculate the dispersion degree of the sub-regions in which the persons 30B are located (captured) as the density of the persons 30B in the region P.

Alternatively, the first calculation unit 12B may divide the region P into a plurality of sub-regions and calculate, for each sub-region, the number of persons 30 captured in the sub-region. Then, the first calculation unit 12B may calculate an average of the number of persons 30B captured in the sub-regions as the density of the persons 30B in the region P.

The first calculation unit 12B may calculate the density of the objects (in the embodiment, the persons 30B) captured in each region P using a known detection method. For example, the first calculation unit 12B detects, for each region P, the number of faces using a known face detection technique. The first calculation unit 12B divides, for each region P, the number of detected faces by the number of pixels included. in the region P. The first calculation unit 12B may use, for each region P, the value (division result) obtained by the division as the density of the persons 30B in the region P.

When the first acquisition unit 12A acquires an image taken by an infrared camera, the acquired image tends to have large pixel values in the region in which the person is captured. In this case, the first calculation unit 12B divides, for each region P, the number of pixels each having a pixel value equal to or larger than a certain threshold by the number of pixels included in the region P. The first calculation unit 12B may use, for each region P, the value (division result) obtained by the division as the density of the persons 30B in the region P.

When the first acquisition unit 12A acquires a distance image (depth image) taken by a depth camera, the first calculation unit 12B divides, for each region P, the number of pixels indicating a height above the ground from 80 cm to 2 m by the number of pixels included in the region P. The first calculation unit 12B may use, for each region P, the value (division result) obtained by the division as the density of the persons 30B in the region P.

The first calculation unit 12B may calculate the density of the persons 30B in the region P using a calculation method of a provisional density, which is described later in detail in a fourth embodiment.

When the first calculation unit 12B calculates the density of the objects captured in each region P for each of the object classes captured in the image 30, it is preferable to use a calculation method described later in detail in a third embodiment from a point of view of increasing an accuracy in density calculation for each object class.

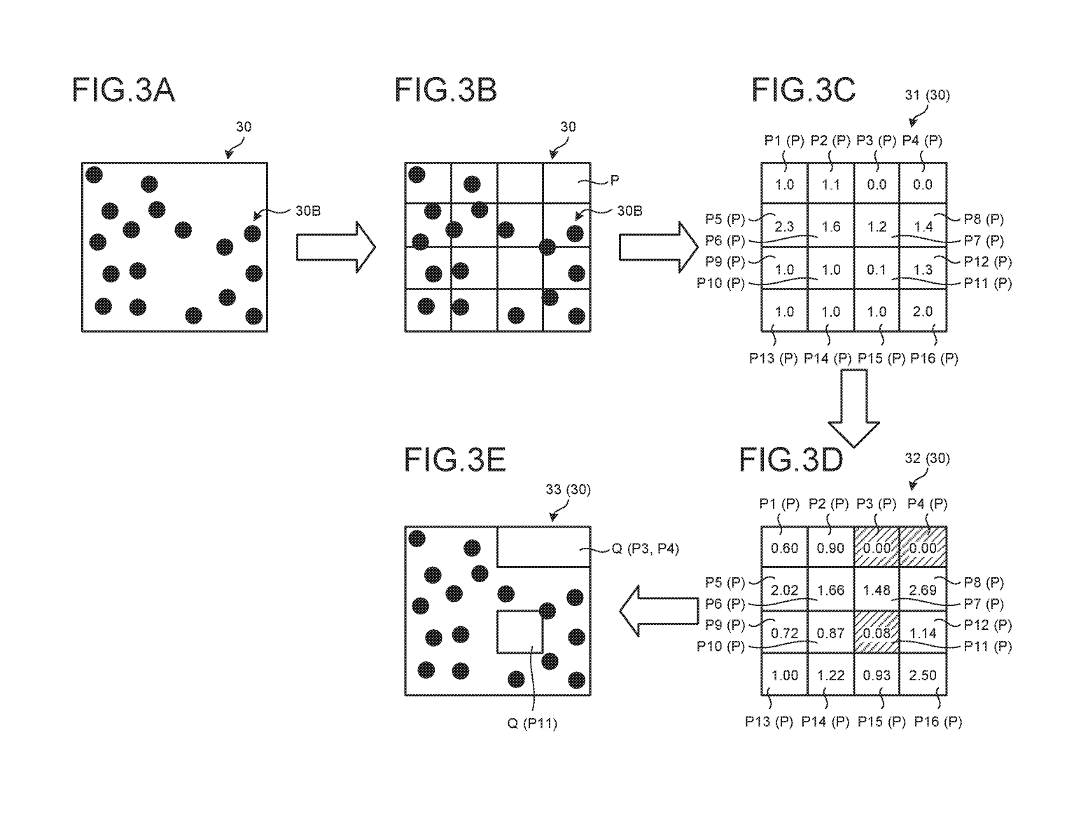

FIGS. 3A to 3B are schematic diagrams illustrating a flow of the processing performed on the image 30. The first acquisition unit 12A acquires the image 30 illustrated in FIG. 3A, for example. The first calculation unit 12B divides the image 30 into the multiple regions P. FIG. 3B illustrates the case where the first calculation unit 12B divides the image 30 into a matrix of 4×4 regions P, that is, 16 regions P in total.

The first calculation unit 12B calculates, for each region P, the density of the persons 30B. FIG. 3C illustrates an example of a density distribution 31. As illustrated in FIG. 3C, the first calculation unit 12B calculates, for each of the regions P1 to P16, the density of the persons 30B captured in the region P. As a result, the first calculation unit 12B obtains the density distribution 31.

Referring back to FIG. 1, the computation unit 12C calculates a first density relative value of the region to a surrounding region which is surrounding P. The first density relative value is a relative value of the density of the objects in the region P with respect to the density of the objects in the surrounding region of the region P. In the following description, the density of the objects (the persons 30B in the embodiment) is simply described as the density in some cases.

The surrounding region of the region P includes at least regions P continuously arranged in the surrounding of the region P in the image 30. The other regions P continuously arranged in the surrounding of the region P means that the regions P are arranged in contact with the region P.

As long as the surrounding region of the region P includes at least regions P continuously arranged in the surrounding of the region P, it serves as the purpose. For example, the surrounding region of the region P may further include multiple regions P arranged continuously in a direction away from a position being in contact with the region P.

In the embodiment, the computation unit 12C sequentially sets each of the regions P divided by the first calculation unit 12B in the image 30 as a first region serving as the calculation target of the first density relative value. The computation unit 12C calculates the first density relative value of the first region with respect to the density in the surrounding region. The surrounding region includes a plurality of second regions arranged in the surrounding of the first region. As a result, the computation unit 12C calculates the first density relative values of the respective regions P.

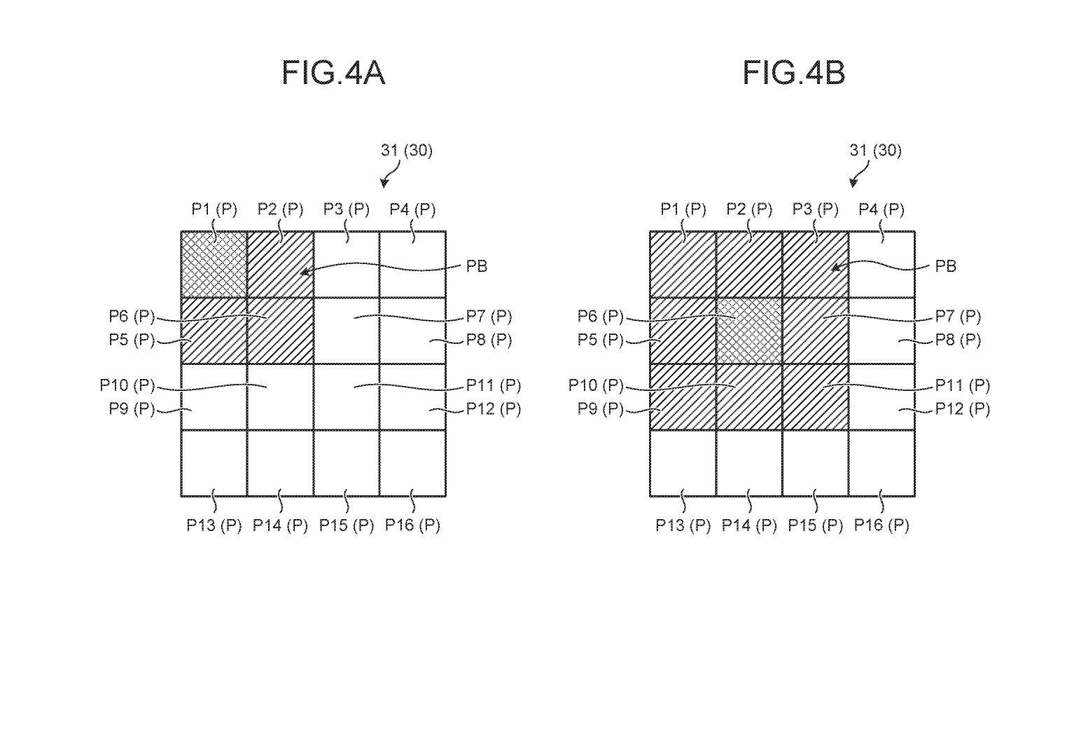

FIGS. 4A and 4B are explanatory views illustrating examples of calculation of the first density relative value. The computation unit 12C sequentially sets each of the regions P (regions P1 to P16) in the image 30 as the first region, and calculates the first density relative values of the respective first regions (regions P1 to P16).

FIG. 4A illustrates a state in which the computation unit 12C sets the region P1 as the first region. In this case, a surrounding region PB of the region P1 includes the regions P2, P5, and P6, which are continuously arranged in the surrounding of the region P1, for example. As described above, those regions (regions P2, P5, and P6) included in the surrounding region PB correspond to the second regions. The regions P included in the surrounding region PB are, thus, simply described as the second regions in some cases in the following description.

In this case, the computation unit 12C calculates an average of the densities in the regions P2, P5, and P6, which are the second regions included in the surrounding region PB, as the density of the persons 30B in the surrounding region PB. For example, the computation unit 12C calculates the density of the persons 30B in the surrounding region PB by dividing the sum of the densities in the regions P2, P5, and P6, which are the second regions included in the surrounding region PB, by the number of second regions (in this case, “three”) included in the surrounding region PB.

The computation unit 12C calculates the relative value of the density in the region P1 with respect to the density in the surrounding region PB as the first density relative value of the region P1.

FIG. 4B illustrates a state in which the computation unit 12C sets the region P6 as the first region. In this case, the surrounding region PB of the region P6 serving as the first region includes the regions P1 to P3, the regions P5 and P7, and the regions P9 to P11, which are arranged in contact with the region P6, for example.

The computation unit 12C calculates an average of the densities in the regions P1 to P3, the regions P5 and P7, and the regions P9 to P11, which are the second regions included in the surrounding region PB, as the density of the persons 30B in the surrounding region PB. The computation unit 12C calculates the density of the persons 30B in the surrounding region PB by dividing the sum of the densities in the regions P1 to P3, the regions P5 and P7, and the regions P9 to P11, which are the second regions included in the surrounding region PB, by the number of second regions (in this case, “eight”) included in the surrounding region PB.

The computation unit 12C calculates the relative value of the density in the region P6 with respect to the density in the surrounding region PB as the first density relative value of the region P6.

The computation unit 12C sequentially sets each of the regions P2 to P5, and the regions P7 to P16 as the first region, and calculates the first density relative values of the respective first regions with respect to the surrounding region PB thereof in the same manner as described above.

The calculation method of the first density relative value by the computation unit 12C is not limited to the method using the average obtained by simply averaging the densities in the second regions included in the surrounding region PB.

For example, the computation unit 12C may calculate the first density relative value using an average by weighted averaging according to the distances between each second region included in the surrounding region PB and the first region.

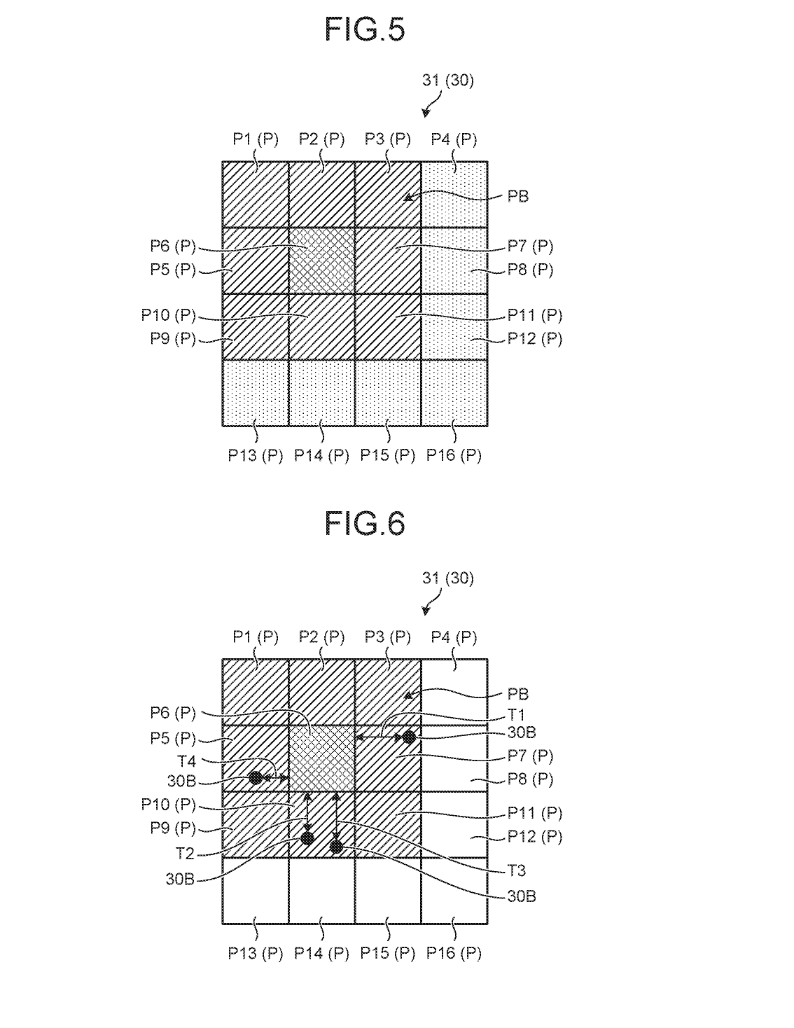

FIG. 5 is an explanatory view of the calculation of the first density relative value using the weighted average.

FIG. 5 illustrates a state in which the computation unit 12C sets the region P6 as the first region. FIG. 5 illustrates the case where the surrounding region PB of the region P6 serving as the first region further includes the multiple regions P arranged in a direction away from a position being in contact with the region P6. In short, in the example illustrated in FIG. 5, the surrounding region PB of the region P6 includes the regions P (P1 to P3, P5, P7, and P9 to P11) that are continuously arranged in contact with the region P6, and further includes the regions P (P4, P8, and P12 to P16) continuing from the region P6 via the regions P (P1 to P3, P5, P7, and P9 to P11) that are in contact with the region P6. Thus, in FIG. 5, the second regions included in the surrounding region PB of the region P6 are the regions P1 to P5, and the regions P7 to P16.

In this case, the computation unit 12C multiplies each density in the second regions included in the surrounding region PB by a first weight value m. For example, m has a value equal to or larger than zero and smaller than one. The first weight value m has a larger value when the corresponding one of the second regions is disposed closer to the set first region (the region P6 in FIG. 5).

The computation unit 12C preliminarily stores therein the distance from the first region and the first weight value m in association with each other.

The computation unit 12C multiplies the density of the persons 30B in each second region included in the surrounding region PB by the first weight value m corresponding to the distance from the first region to the second region. For example, the computation unit 12C multiplies the first weight value m of “0.8” by the respective densities in the second regions (the region P1 to P3, the regions P5 and P7, and the regions P9 to P11) that are in contact with the region P6 serving as the first region. The computation unit 12C multiplies the first weight value m of “0.5” by the respective densities in the second regions (the regions P4, P8, and P12, and the regions P13 to P16) that are arranged away from the region P6 as compared with the second regions that are in contact with the region P6.

As a result, the computation unit 12C calculates, for each second region, the multiplication value obtained by multiplying the density in the second region by the corresponding first weight value m.

The computation unit 12C calculates the average of the multiplication values calculated for the respective second regions included in the surrounding region PB as the density in the surrounding region PB. The computation unit 12C calculates the sum (sum of the multiplication values on 15 second regions, in this case) of the multiplication values obtained by multiplying the respective densities in the second regions included in the surrounding region PB by the corresponding first weight values m. The computation unit 12C calculates the average by dividing the sum by the number of second regions (“15” in this case) included in the surrounding region PB.

The computation unit 12C uses the average as the density in the surrounding region PB of the region P6. The computation unit 12C calculates the relative value of the density in the region P6 set as the first region with respect to the density (the calculated average) in the surrounding region PB as the first density relative value of the region P6. The computation unit 12C calculates the first density relative value for each of the regions P (the regions P1 to P5 and the regions P7 to P16) in the same manner as described above.

In this way, the computation unit 12C may calculate the first density relative value using an average by weighted averaging according to the distances between each second region included in the surrounding region PB and the first region.

Alternatively, the computation unit 12C may calculate the first density relative value using an average by weighted averaging according to the distances between the persons 30B captured in each second region included in the surrounding region PB and the first region.

FIG. 6 is another explanatory view of the calculation of the first density relative value using the weighted average.

FIG. 6 illustrates that the computation unit 12C sets the region P6 as the first region. In FIG. 6, the surrounding region PB of the region P6 serving as the first region includes the regions P1 to P3, the regions P5 and P7, and the regions P9 to P11, which are arranged in contact with the region P6.

In this case, the computation unit 12C multiplies each density in the second regions included in the surrounding region PB by a second weight value n. For example, n has a value equal to or larger than zero and smaller than one. The second weight value n has a larger value when the distance between the person 30B captured in the second region and the first region (the region P6 in FIG. 6) is smaller.

The computation unit 12C calculates, for each second region included in the surrounding region PB, distances between the persons 30B captured in the second region and the first region, for example. The first calculation unit 12B may calculate, for each region P, the density in the region P and the positions of the persons 30B in the region P, for example. The computation unit 12C may calculate, for each second region included in the surrounding region PB, the distances between the persons 30B captured in the second region and the first region on the basis of the positions of the persons 30B calculated by the first calculation unit 12B.

The computation unit 12C calculates a division value obtained by dividing a numerical value of “1” by the distance between the person 30B and the first region as the second weight value n in the second region that includes the person 30B. When the distance between the person 30B captured in the second region and the first region is smaller, a larger second weight value n is calculated.

When the multiple persons 30B are present in the second region, the computation unit 12C calculates, for each person 30B captured in the second region, a division value obtained by dividing a numerical value of “1” by the distance between the person 30B and the first region. The computation unit 12C may calculate the sum of the division values calculated for the respective persons 30B captured in the same second region as the second weight value n in the second region. When the number of persons 30B captured in the second region is larger, a larger second weight value n is calculated.

As for the second region that includes no person 30B, in the image 30, a value smaller than the minimum in the second weight values n in the second regions that include the persons 30B may be calculated as the second weight value n.

For example, as illustrated in FIG. 6, one person 30B is captured in the region P7 of the second regions included in the surrounding region PB of the region P6 serving as the first region. It is assumed that the distance between the person 30B and the region P6 is T1. In this case, the computation unit 12C may calculate 1/T1 as the second weight value n in the region P7.

The region P10 includes the two persons 30B. It is assume that the distance between one person 30B and the region P6 is T2 while the distance between the other person 30b and the region P6 is T3. In this case, the computation unit 12C may calculate a value obtained by calculation of (1/T2+1/T3) as the second weight value n in the region P10.

The region P5 includes one person 30B. It is assumed that the distance between the person 30B and the region P6 is T4. In this case, the computation unit 12C may calculate 1/T4 as the second weight value n in the region P5.

No person 30B is captured in the regions P1 to P3, and the regions P9 and P11 in the surrounding region PB. The computation unit 12C may calculate the second weight value n as the minimum (e.g., 0.01) in the regions P in the image 30 as the second weight value n in the respective regions P including no person 30B, for example.

The computation unit 12C calculates the average of the multiplication values obtained by multiplying the respective densities in the second regions included in the surrounding region PB by the corresponding second weight values n as the density in the surrounding region PB. The computation unit 12C calculates the sum of the multiplication values obtained by multiplying the respective densities in the second regions included in the surrounding region PB by the corresponding second weight values n. The computation unit 12C calculates the average by dividing the sum by the number of second regions included in the surrounding region PB. The computation unit 12C calculates the average as the density of the persons 30B in the surrounding region PB.

Then, the computation unit 12C calculates the relative value of the density in the region P6 set as the first region with respect to the calculated density in the surrounding region PB as the first density relative value of the region P6. The computation unit 12C may calculate the first density relative value for each of the regions P (the regions P1 to P5 and the regions P7 to P16) by sequentially setting the regions P as the first region in the same manner as described above.

In this way, the computation unit 12C may calculate the first density relative value using an average by weighted averaging according to the distances between the objects (the persons 30B) in the respective second regions included in the surrounding region PB and the first region.

When the calculation result of the density in the surrounding region PB is “zero”, the computation unit 12C preferably corrects the value of the density in the surrounding region PB such that the value is larger than zero and smaller than the minimum in the densities in the respective surrounding regions PB corresponding to the other first regions. For example, when the calculation result of the density in the surrounding region PB of a certain first region is “zero”, the computation unit 12C may correct the density in the surrounding region PB to “0.00001”. The computation unit 12C may calculate the first density relative value using the corrected density in the surrounding region PB.

In this way, the computation unit 12C may calculate, for each region P, the first density relative value with respect to the density of the objects in the surrounding region of the region P.

FIG. 3D is a schematic diagram illustrating an example of a relative value distribution 32 in which the first density relative value is specified for each region P. The computation unit 12C calculates a first density relative distribution for each region P using the density distribution 31 (refer to FIG. 3C) in the same manner as described above to produce the relative value distribution 32, for example.

Referring back to FIG. 1, the detection unit 12D detects, as the attention region, the region P having the first density relative value larger than a first threshold or smaller than the first threshold out of the multiple regions P included in the image 30.

The value of the first threshold may be appropriately set in accordance with the target for detecting the attention region. The first threshold may be appropriately changeable in accordance with the user's instruction using the UI unit 16, for example.

The following describes the detection of an attention region Q with reference to FIGS. 3A to 3E. It is assumed that the relative value distribution 32 illustrated in FIG. 3D is obtained by the computation unit 12C. The first threshold is assumed to be “0.1”. It is assumed that the computation unit 12C detects the region P having the first density relative value smaller than the first threshold as the attention region Q.

In this case, the detection unit 12D detects the regions P3, P4, and P11 as the attention regions Q (refer to FIGS. 3D and 3E). The regions P3, P4, and P11 each have the first density relative value smaller than the first threshold of “0.1” out of the regions P (the regions P1 to P16) included in the image 30. When the regions P each having the first density relative value smaller than the first threshold are continuously arranged in the image 30, the continuous regions P may be collectively set as the attention region Q. Specifically, as illustrated in FIG. 3D, the detection unit 12D may detect the regions P3 and P4 each having the first density relative value smaller than the first threshold as the attention region Q collectively.

The first threshold may have a single value or have a value ranging from an upper limit value to a lower limit value. When the first calculation unit 12B calculates the dispersion degree of the persons 30B in each region P as the density of the persons 30B in the region P, it is preferable that the first threshold have a range from a viewpoint of taking into consideration of the dispersion degree.

Alternatively, the detection unit 12D may detect, as the attention region Q, the region P having the first density relative value equal to or larger or smaller than the first threshold by a predetermined rate (e.g., 10%). When the first threshold has a range, the detection unit 12D may detect, as the attention region Q, the region P having the first density relative value equal to or smaller than the lower limit value of the first threshold by a predetermined rate or the region P having the first density relative value equal to or larger than the upper limit value of the first threshold by the predetermined rate.

Referring back to FIG. 1, the display controller 12E controls the display 16A to display various images. In the embodiment, the display controller 12E displays the attention region Q detected by the detection unit 12D on the display 16A.

The display controller 12E may display textual information that indicates the attention region Q on the display 16A. The display controller 12E may display a display image that indicates the attention region Q on the display 16A. The form of the display image indicating the attention region Q is not limited to any specific form. For example, the display image indicating the attention region Q may be coordinate information that indicates the position of the attention region Q in the image 30. When the attention region Q has a rectangular shape, the coordinate information may indicate the coordinates of the respective vertexes of the attention region Q, for example. The coordinate information may indicate the coordinates of both ends of the lines that enclose the attention region Q. The display image indicating the attention region Q may be identification information about the region P detected as the attention region Q.

FIG. 3E is a schematic diagram illustrating an example of a display image 33. The display controller 12E displays, on the display 16A, the display image 33 in which a profile line indicating the outline of the attention region Q is superimposed on the image 30.

The display controller 12E preferably displays, on the display 16A, the display image 33 that indicates the attention region Q in the image 30 in a different display form from that of the external region of the attention region Q.

Specifically, the display controller 12E preferably displays the attention region Q in a display form that prompts the user's attention to the attention region Q. The display form that prompts the user's attention means an emphasized display form. Examples of the method for displaying the attention region Q in the display form that prompts the user's attention to the attention region Q are as follows: the attention region Q is displayed in a different color from that of the background; the attention region Q is displayed in a color having high intensity and saturation; the attention region Q is displayed by being blinked; the attention region Q is displayed by being enclosed with a bold line; the attention region Q is displayed by being enlarged; and the attention region Q is displayed while the external region of the attention region Q in the image 30 is distorted.

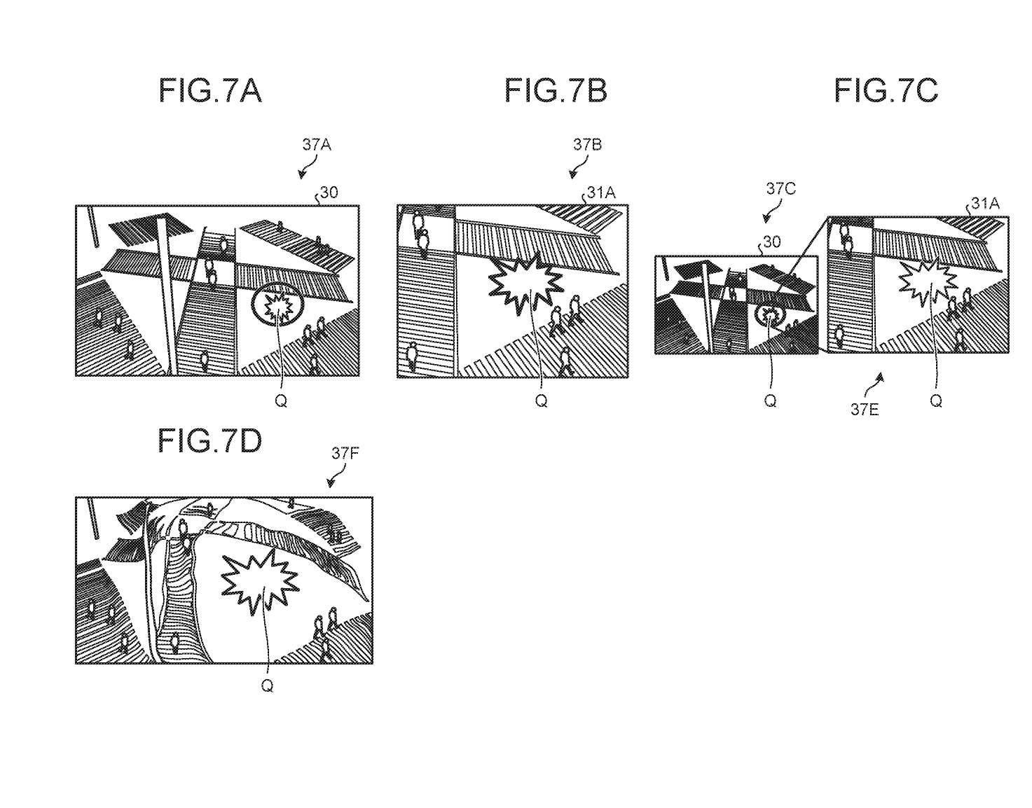

FIGS. 1A to 7D are schematic diagrams illustrating examples of the display image. The display controller 12E displays, on the display 16A, a display image 37A in which the attention region Q is superimposed on the image 30 in the display form that prompts the user's attention (refer to FIG. 7A). The display controller 12E may display, on the display 16A, an enlarged image 31A in which the attention region Q is enlarged in the image 30 as a display image 37B (refer to FIG. 7B).

A magnification factor applied to the attention region Q may be a predetermined value or adjusted in accordance with the size of the display surface of the display 16A. For example, the display controller 12E may adjust the magnification factor applied to the attention region Q such that the attention region Q is displayed within the display surface of the display 16A. The display controller 12E may adjust the magnification factor applied to the attention region Q in accordance with the value of the first density relative value of the region P detected as the attention region Q. The display controller 12E may increase the magnification factor applied to the attention region Q as the value of the first density relative value of the region P detected as the attention region Q is larger. In contrast, the display controller 12E may increase the magnification factor applied to the attention region Q as the value of the first density relative value of the region P detected as the attention region Q is smaller.

The display controller 12E may display, on the display 16A, a display image 37E that includes a display image 37C in which the image indicating the attention region Q is superimposed on the image 30, and the enlarged image 31A of a partially enlarged image of the attention region Q (refer to FIG. 7C).

The display controller 12E may display, on the display 16A, a display image 37F in which the attention region Q is partially enlarged and the external region of the attention region Q in the image 30 is distorted (refer to FIG. 7D). Known methods may be used for distorting the external region.

The display form of the attention region Q is not limited to the examples described above. For example, the display controller 12E may display the attention region Q on the display 16A in a display form according to the first density relative values of the regions P included in the attention region Q.

For example, the display controller 12E may display the attention region Q on the display 16A in such a manner that the attention region Q is displayed in a color having at least one of high intensity, high saturation, and high density as the first density relative values of the regions P included in the attention region Q are larger.

The display controller 12E may further display an attention neighborhood region on the display 16A. In this case, the display controller 12E identifies the regions P outside the attention region Q as the attention neighborhood regions. The attention neighborhood regions are the regions P outside the attention region Q and from which the object enters the attention region P with high possibility. The display controller 12E identifies the following regions P other than the attention region Q as the attention neighborhood regions, for example: the region P that has the first density relative value, the difference between which and the first density relative value of the attention region Q is equal to or smaller than a threshold; the region P, the distance between which and the attention region Q is equal to or smaller than a threshold; and the region P, the product or weighted sum of the difference and the distance between which and the attention region Q is equal to or larger than a threshold. The display controller 12E may display the attention region Q and the attention neighborhood regions on the display 16A.

The following describes a procedure of the image processing performed by the image processing apparatus 10 in the embodiment.

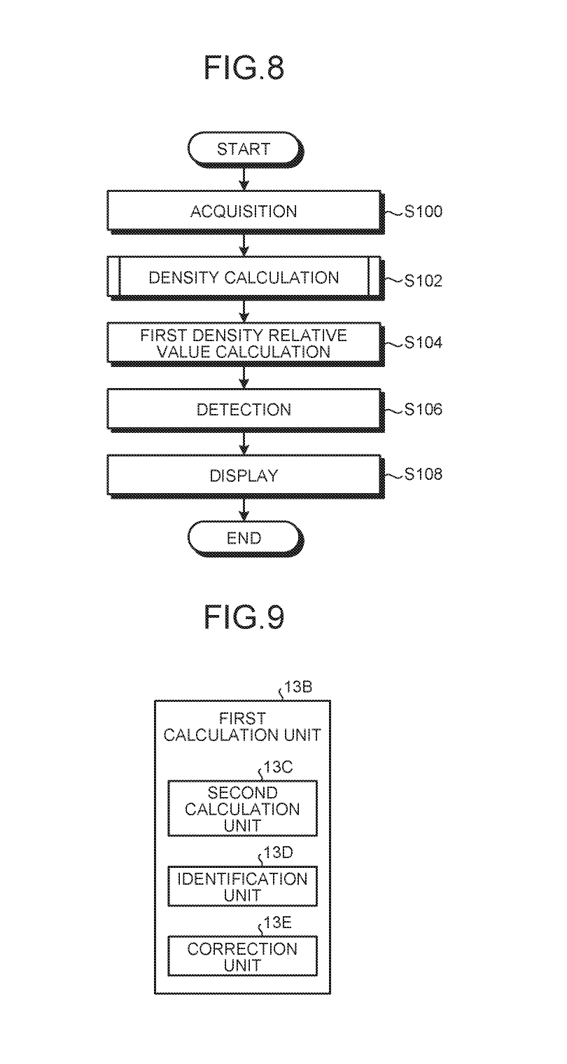

FIG. 8 is a flowchart illustrating an exemplary procedure of the image processing performed by the image processing apparatus 10 in the embodiment.

The first acquisition unit 12A acquires the image 30 that is the target for detecting the attention region Q (step S100). The first calculation unit 12B calculates, for each of the regions P obtained by dividing the image 30 acquired at step S100, the density of the objects (persons 30B) captured in the region P (step S102).

The computation unit 12C calculates, for each region P, the first density relative value with respect to the density of the persons 30B in the surrounding region PB of the region P (step S104). The detection unit 12D detects, as the attention region Q, the region P having the first density relative value, which is calculated at step S104), larger than the first threshold or smaller than the first threshold, out of the multiple regions P included in the image 30 (step S106).

The display controller 12E displays the display image indicating the attention region Q detected at step S106 on the display 16A (step S108). Then, this routine ends.

As described above, the image processing apparatus 10 in the embodiment includes the first acquisition unit 12A, the first calculation unit 12B, the computation unit 12C, and the detection unit 12D. The first acquisition unit 12A acquires the image 30. The first calculation unit 12B calculates the density of the objects (persons 30B) captured in the region P obtained by dividing the image 30. The computation unit 12C calculate the first density relative value of the region to the surrounding region PB which is surrounding the region P. The detection unit 12D detects an attention region out of the regions included in the image 30 according to the first density relative value.

In the conventional techniques, it is determined whether the density of the persons in the image differs from a reference density by a value equal to or larger than a threshold, so as to detect the attention region. As a result, the attention region is incorrectly identified especially when the density of persons captured in the image is overall high (e.g., the density is double overall) or when the density of persons captured in the image is overall low.

In contrast, the image processing apparatus 10 according to the embodiment detects the attention region Q using the first density relative value, which is the relative value of the density with respect to the density in the surrounding region PB of the region P, calculated for each region P. The image processing apparatus 10, thus, can accurately detect the region P having a different density from those in the other regions P as the attention region Q even if the density of the objects in the image 30 is overall larger or smaller than a predetermined reference density.

The image processing apparatus 10 according to the embodiment, thus, can accurately detect the attention region Q in the image 30.

As the surrounding region used for the calculation of the first density relative value, the computation unit 12C may use the surrounding region in another image taken at a different time.

In the embodiment, a person (person 30B) is an example of the object. The object is not limited to a person. Any object is available that is imaged and identified by analyzing the image of the object. Examples of the object may include a vehicle, an animal, a plant, a cell, a bacterium, pollen, and X-rays.

In the embodiment, the computation unit 12C detects, as the attention region Q, the region P having the first density relative value smaller than the first threshold, as an example. The computation unit 12C may detect, as the attention region Q, the region P having the first density relative value larger than the first threshold.

The first threshold may include two different thresholds where one threshold (a small threshold) is larger than the other threshold (a large threshold). In this case, the computation unit 12C may detect, as the attention region Q, the region P having the first density relative value smaller than the small threshold in the first threshold. The computation unit 12C may detect, as the attention region Q, the region P having the first density relative value larger than the large threshold in the first threshold.

### First Modification

The first calculation unit 12B may correct the density of the persons 30B calculated for each region P in the image 30 in accordance with the density in the surrounding region PB of the corresponding region P.

FIG. 1 is a block diagram illustrating an image processing apparatus 11 according to a first modification.

The image processing apparatus 11 includes the imager 23, the storage 14, the UI unit 16, and a controller 13. The image processing apparatus 11 has the same structure as the image processing apparatus 10 in the first embodiment except that the image processing apparatus 11 includes the controller 13 instead of the controller 12.

The controller 13 includes the first acquisition unit 12A, a first calculation unit 13B, the computation unit 12C, the detection unit 12D, and the display controller 12E. The controller 13 has the same structure as the controller 12 in the first embodiment except that the controller 13 includes the first calculation unit 13B instead of the first calculation unit 12B.

FIG. 9 is a block diagram illustrating the first calculation unit 13B. The first calculation unit 13B includes a second calculation unit 13C, an identification unit 13D, and a correction unit 13E.

The second calculation unit 13C calculates, for each of the regions P obtained by dividing the image 30, the density of the objects captured in the region P. The second calculation unit 13C calculates the density of the objects captured in the region P in the same manner as the first calculation unit 12B in the first embodiment.

The identification unit 13D identifies the region P where the density calculated by the second calculation unit 13C is larger than a second threshold, out of the multiple regions P included in the image 30.

The identification unit 13D may preliminarily set any value to the second threshold. For example, the identification unit 13D may preliminarily determine, as the second threshold, a threshold of a determination criterion whether at least some of the persons 30B exist over the region P and the other regions P. For example, when the number of persons 30B captured in one region P is larger, the possibility of a part of the body of the person 30B captured also in the other regions P is high. The identification unit 13D, thus, may determine the second threshold from such a point of view. The second threshold may be appropriately changeable in accordance with the user's instruction using the UI unit 16.

The correction unit 13E multiplies a third weight value p by each density in the regions P included in the surrounding region PB of the identified region P. The third weight value p has a value larger than zero and smaller than one. The correction unit 13E calculates the sum of the density in the identified region P and the multiplication values obtained by multiplying the third weight value p by each density in the regions P included in the surrounding region PB. The correction unit 13E corrects the density in the region P identified by the identification unit 13D to the sum. That is, the correction unit 13E uses the sum as the corrected density in the region P identified by the identification unit 13D.

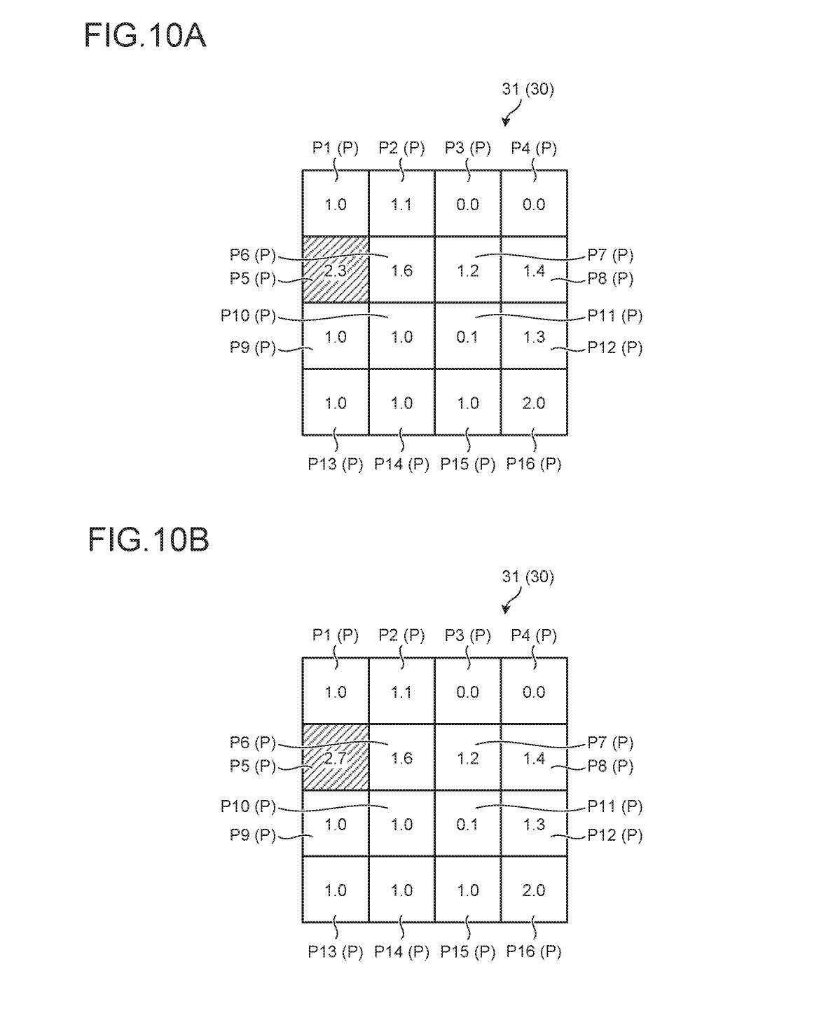

FIGS. 10A and 10B are explanatory views of the calculation of the density of the objects by the first calculation unit 13B.

FIG. 10A is a schematic diagram illustrating an example of the density distribution 31. The second calculation unit 13C calculates the density of the persons 30B for each region P in the same manner as the first calculation unit 12B. As a result, the second calculation unit 13C obtains the density distribution 31.

The second threshold is assumed to be “2.1”, for example. In this case, the identification unit 13D identifies the region P5 where the density, which is “2.3”, is larger than “2.1” in the density distribution 31. The correction unit 13E adds the density of “2.3” in the identified region P5 to the multiplication values obtained by multiplying the second threshold by each density in the regions P (the regions P1, P2, P6, P9, and P10) included in the surrounding region PB of the region P5. The sum, which is the result of the addition, is assumed to be “2.7”. In this case, the correction unit 13E corrects the density in the region P5 to “2.7” (refer to FIG. 10B).

Referring back to FIG. 1, the computation unit 12C calculates, for each region P, the first density relative value using the density in the region P indicated by the density distribution 31 after the correction (refer to FIG. 10B) in the same manner as the first embodiment.

The following describes a procedure of the image processing performed by the image processing apparatus 11 in the first modification.

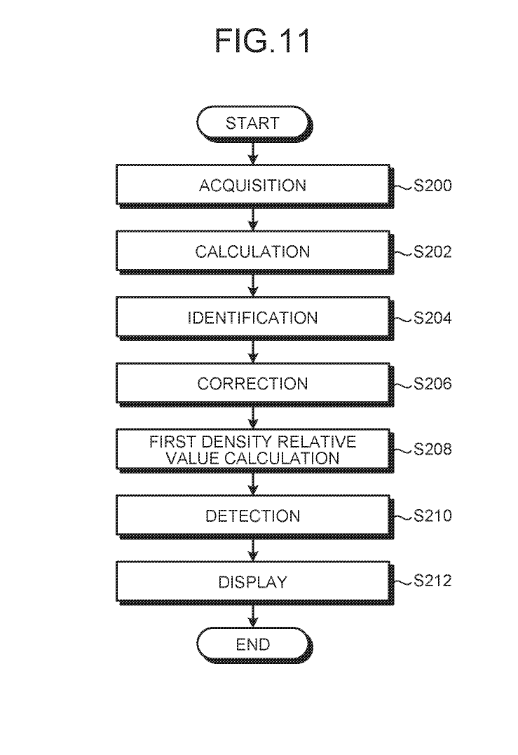

FIG. 11 is a flowchart illustrating an exemplary procedure of the image processing performed by the image processing apparatus 11 in the modification.

The first acquisition unit 12A acquires the image 30 that is the target for detecting the attention region Q (step S200). The second calculation unit 13C of the first calculation unit 13B calculates, for each of the regions P obtained by dividing the image 30 acquired at step S200, the density of the objects (persons 30B) captured in the region P (step S202).

The identification unit 13D identifies the region P where the density is larger than the second threshold (step S204). The correction unit 13E corrects the density in the identified region P using the densities in the surrounding region PB of the region P (step S206).

The computation unit 12C calculates, for each region P, the first density relative value with respect to the density of the persons 30B in the surrounding region PB of the region P (step S208). At step S208, the computation unit 12C calculates the first density relative value using the density corrected at step S206.

The detection unit 12D detects, as the attention region Q, the region P having the first density relative value, which is calculated at step S208, larger than the first threshold or smaller than the first threshold, out of the multiple regions P included in the image 30 (step S210). The display controller 12E displays the display image indicating the attention region Q detected at step S210 on the display 16A (step S212). Then, this routine ends.

As described above, in the first modification, the computation unit 12C calculates, for each region P, the first density relative value using the density corrected by the first calculation unit 13B (the correction unit 13E).

When the image 30 is divided into the regions P, the partition between the regions P is disposed at the position in which the partition divides the person 30B captured in the image 30B in some cases. In this case, the calculated density varies depending on the position of the partition between regions P, which partition divides the person 30B, in some cases.

The correction by the first calculation unit 13B makes it possible to more accurately calculate, for each region P, the density of the persons 30B in the region P. The image processing apparatus 11 in the modification, thus, can detect the attention region Q in the image 30 more accurately than the image processing apparatus 10 in the first embodiment.

In the modification, the correction unit 13E corrects the density in the region P identified by the identification unit 13D. The correction unit 13E may correct the density in each of all the regions P included in the image 30 in the same manner as described above.

### Second Modification

In the first embodiment, the image processing apparatus 10 detects the attention region Q using a single piece of the image 30 acquired by the first acquisition unit 12A, as an example. The image processing apparatus 10 may detect the attention region Q using a plurality of images 30 that continue in time series and are acquired by the first acquisition unit 12A.

FIG. 1 is a block diagram illustrating an image processing apparatus 15 according to a second modification.

The image processing apparatus 15 includes the imager 23, the storage 14, the UI unit 16, and a controller 17. The image processing apparatus 15 has the same structure as the image processing apparatus 10 in the first embodiment except that the image processing apparatus 15 includes the controller 17 instead of the controller 12.

The controller 17 includes a first acquisition unit 17A, a first calculation unit 17B, a computation unit 17C, a detection unit 17D, and a display controller 17E. A part or the whole of the first acquisition unit 17A, the first calculation unit 17B, the computation unit 17C, the detection unit 17D, and the display controller 17E may be implemented by causing a processing unit such as a CPU to execute a program, that is, by software, hardware such as an IC, or by both of software and hardware.

The first acquisition unit 17A acquires a plurality of images 30 captured in time series. The multiple images 30 continuing in time series are plurality of taken images in time series obtained by imaging a certain imaging region (e.g., an intersection or a road) in a real space. The first acquisition unit 17A performs the acquisition in the same manner as the first acquisition unit 12A in the first embodiment except that the first acquisition unit 17A acquires the multiple images 30 continuing in time series instead of a single piece of the image 30.

The first calculation unit 17B calculates, for each of the images 30 acquired by the first acquisition unit 17A and for each of the regions P obtained by dividing the image 30, the density of the objects captured in the region P. The first calculation unit 17B calculates the density of the objects in each region P in the same manner as the first calculation unit 12B in the first embodiment except that the calculation is performed on each of the images 30 continuing in time series instead of a single piece of the image 30.

The computation unit 17C calculates, for each of the images 30, the first density relative value for each region P included in the image 30. The computation unit 17C calculates the first density relative value for each region P included in the image 30 in the same manner as the computation unit 12C in the first embodiment except that the calculation is performed on each of the images 30 continuing in time series instead of a single piece of the image 30.

The detection unit 17D detects the attention region Q for each of the images 30. The detection unit 17D detects the attention region Q in the same manner as the detection unit 12D in the first embodiment except that the detection is performed on each of the images 30 continuing in time series instead of a single piece of the image 30.

The display controller 17E calculates an expansion speed or a moving speed of the attention region Q using the attention regions Q detected in the respective images 30. The expansion speed and the moving speed of the attention region Q may be calculated using known image processing.

The display controller 17E displays, on the display 16A, the display image that indicates the attention region Q in a display form according to the expansion speed or the moving speed.

For example, the display controller 17E displays, on the display 16A, the display image that includes the attention region Q in a display form prompting further attention as the expansion speed of the attention region Q is faster. For example, the display controller 17E displays, on the display 16A, the display image that includes the attention region Q in a display form prompting further attention as the moving speed of the attention region Q is faster.

The following describes a procedure of the image processing performed by the image processing apparatus 15 in the second modification.

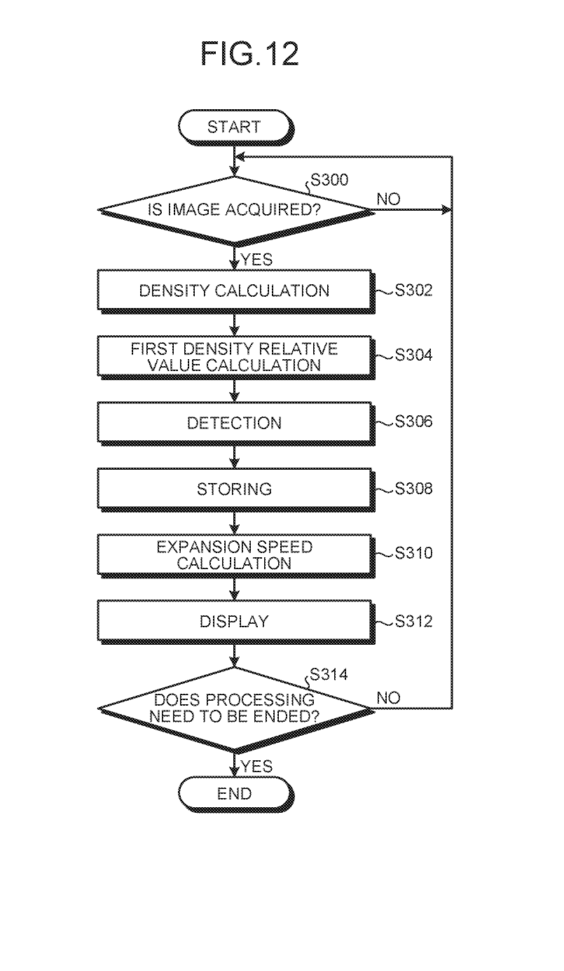

FIG. 12 is a flowchart illustrating an exemplary procedure of the image processing performed by the image processing apparatus 15 in the modification.

The first acquisition unit 17A determines whether the first acquisition unit 17A acquires the image 30 that is the target for detecting the attention region Q (step S300). The first acquisition unit 17A repeats the negative determination (No at step S300) until the positive determination (Yes at step S300) is made at step S300.

If the positive determination is made at step S300 (Yes at step S300), the processing proceeds to step S302. At step S302, the first calculation unit 17B calculates, for each region P, the density of the objects (persons 30B) captured in each of the regions P obtained by dividing the image 30 acquired at step S300 (step S302). The computation unit 12C calculates, for each region P, the first density relative value with respect to the density of the persons 30B in the surrounding region PB of the region P (step S304).

The detection unit 17D detects, as the attention region Q, the region P having the first density relative value, which is calculated at step S304, larger than the first threshold or smaller than the first threshold, out of the regions P included in the image 30 (step S306).

The detection unit 17D stores, in the storage 14, the image 30 acquired at step S300, the densities in the respective regions P calculated at step S302, the first density relative values of the respective regions P calculated at step S304, and the attention region Q detected at step S306 in association with one another (step S308). At step S300, the first acquisition unit 17A may further acquire information indicating the imaging date of the image 30. In this case, the detection unit 17D may further store, in the storage 14, the information indicating the imaging date of the image 30 in association with them described above.

The display controller 17E calculates the expansion speed of the attention region Q from the attention regions Q corresponding to the respective images 30 in time series stored in the storage 14 (step S310). For example, the display controller 17E identifies the latest image 30 acquired at step S300 and a predetermined number (e.g., 10 pieces) of images 30 continuing back to the past from the latest image 30. The display controller 17E reads, from the storage 14, the attention regions Q corresponding to the identified respective images 30. The display controller 17E may calculate the expansion speed of the attention region Q using the positions and areas of the read attention regions Q in the respective images 30 and the information indicating the imaging dates of the respective images 30.

The display controller 17E displays, on the display 16A, the display image that indicates the attention region Q in a display form according to the expansion speed calculated at step S310 (step S312). The controller 17 determines whether the processing needs to be ended (step S314). The controller 17 may make the determination at step S314 on the basis whether a signal indicating the end of the processing is received from the UI unit 16 by the user's instruction using the UI unit 16, for example.

If the negative determination is made at step S314 (No at step S314), the processing returns to step S300. If the positive determination is made at step S314 (Yes at step S314), this routine ends.

The display controller 17E may calculate a reduction speed of the attention region Q in accordance with a change in area of the attention region Q, at step S310. The display controller 17E may calculate the moving speed of the attention region Q instead of the expansion speed of the attention region Q. The display controller 17E may calculate both of the expansion speed and the moving speed of the attention region Q.

In this case, at step S312, the display controller 17E may display, on the display 16A, the display image that indicates the attention region Q in a display form according to at least one of the expansion speed, the reduction speed, and the moving speed of the attention region Q.

As described above, the image processing apparatus 15 may detect the attention region Q using the multiple images 30 continuing in time series.

The image processing apparatus 15 in the modification displays, on the display 16A, the display image that indicates the attention region Q in a display form according to at least one of the expansion speed, the reduction speed, and the moving speed of the attention region Q.

The image processing apparatus 15, thus, can provide a change in position and speed of the attention region Q for the user in an easily understandable manner. When a plurality of attention regions Q are included in the image 30, the attention region Q having larger change is displayed in a more different form from those of the other attention regions Q. The image processing apparatus 15, thus, can display, on the display 16A, the display image that prompts the user's attention to the attention region Q that more largely changes.

The image processing apparatus 15 may detect the attention region Q using a cumulative value of the densities of the objects calculated for each region P in the respective images 30 continuing in time series.

In this case, the first calculation unit 17B of the image processing apparatus 15 calculates the density of the objects for each region P in the respective images 30 continuing in time series in the same manner as described above. The first calculation unit 17B sums the calculated densities for each region P corresponding to the same imaging region in the images 30 continuing in time series, so as to calculate the cumulative value of the densities for each region P.

For example, the region imaged by the imager 23 is assumed to be fixed. The first calculation unit 17B sums the calculated densities for each of the regions P disposed at the same position in the images 30. The first calculation unit 17B may calculate the cumulative value of the densities for each region P, in this way.

The computation unit 17C may calculate the first density relative value for each region P using the cumulative value of the densities instead of the density in the region P in the same manner as the computation unit 12C in the first embodiment. The detection unit 17D may detect the attention region Q using the first density relative value calculated by the computation unit 17C in the same manner as the detection unit 12D in the first embodiment.

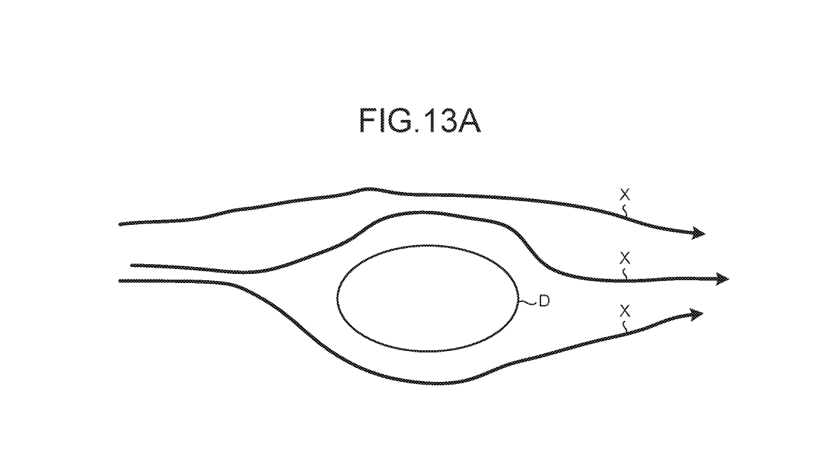

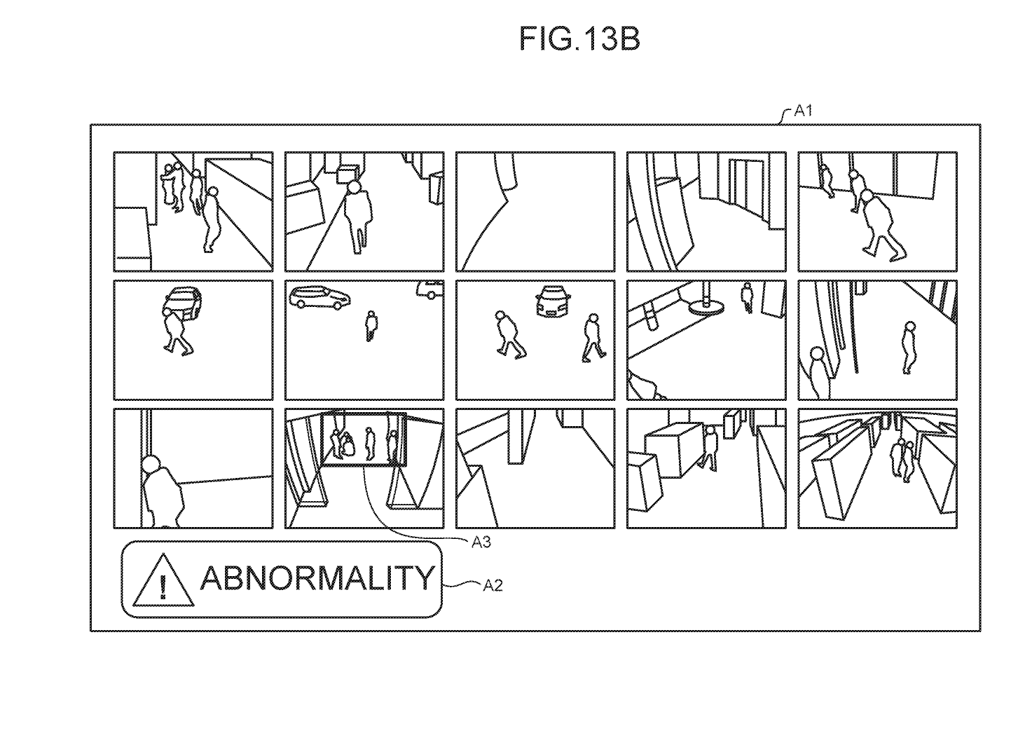

A plurality of persons are assumed to pass through the imaging region of the imager 23 in a real space. FIG. 13A is a schematic diagram illustrating an example of flows of persons (refer to the arrow X directions). In the imaging region, an obstacle D that prevents persons from passing through the imaging region is assumed to be placed, for example. In this case, persons will avoid the obstacle D when passing through the imaging region. The flows of persons (the arrow X directions), thus, move while avoiding the obstacle D.

The image processing apparatus 15 detects the attention region Q by calculating the first density relative value for each region P using the cumulative value of densities instead of the density in the region P, thereby making it possible to detect, as the attention region Q, the region P where the density is higher (or lower) than that in the surrounding region PB in a certain time period in the image 30.

The display controller 17E may display, on the display 16A, the display image that indicates the attention region Q. FIG. 13B is a schematic diagram illustrating an example of a display image A1. The display image A1 illustrated in FIG. 13B can be used for supporting security services.

In general, surveillance cameras (the imagers 23) are provided at various places in buildings and commercial facilities. Monitoring personnel check, in a separate room, whether any abnormalities are present while watching the images from the surveillance cameras. When finding a suspicious person or a suspicious object in an image from the surveillance cameras, the monitoring personnel contact a security company or a neighboring security guard. The security guard who has received the contact goes to the actual spot and deals with the abnormality. As illustrated in FIG. 13B, because the images from many surveillance cameras typically need to be watched simultaneously, it is difficult to find a problem. If the monitoring personnel fail to find a problem or find a problem late, no action can be taken, thereby reducing security service quality.

In contrast, the image processing apparatus 15 in the embodiment detects the attention region Q using the first density relative value. The display controller 17E displays the attention region Q in an emphasized manner (e.g., an annotation A3 is displayed at the attention region Q). In addition, the display controller 17E displays together an annotation A2 that indicates the occurrence of an abnormality, allowing the monitoring personnel to readily pay attention to the occurrence of an abnormality. As a result, the monitoring personnel can find the problem immediately, thereby making it possible to improve the security service quality.

### Third Modification

The detection method of the attention region Q is not limited to the method described in the first embodiment.

For example, the image processing apparatus 10 may detect the attention region Q by setting a boundary between regions P.

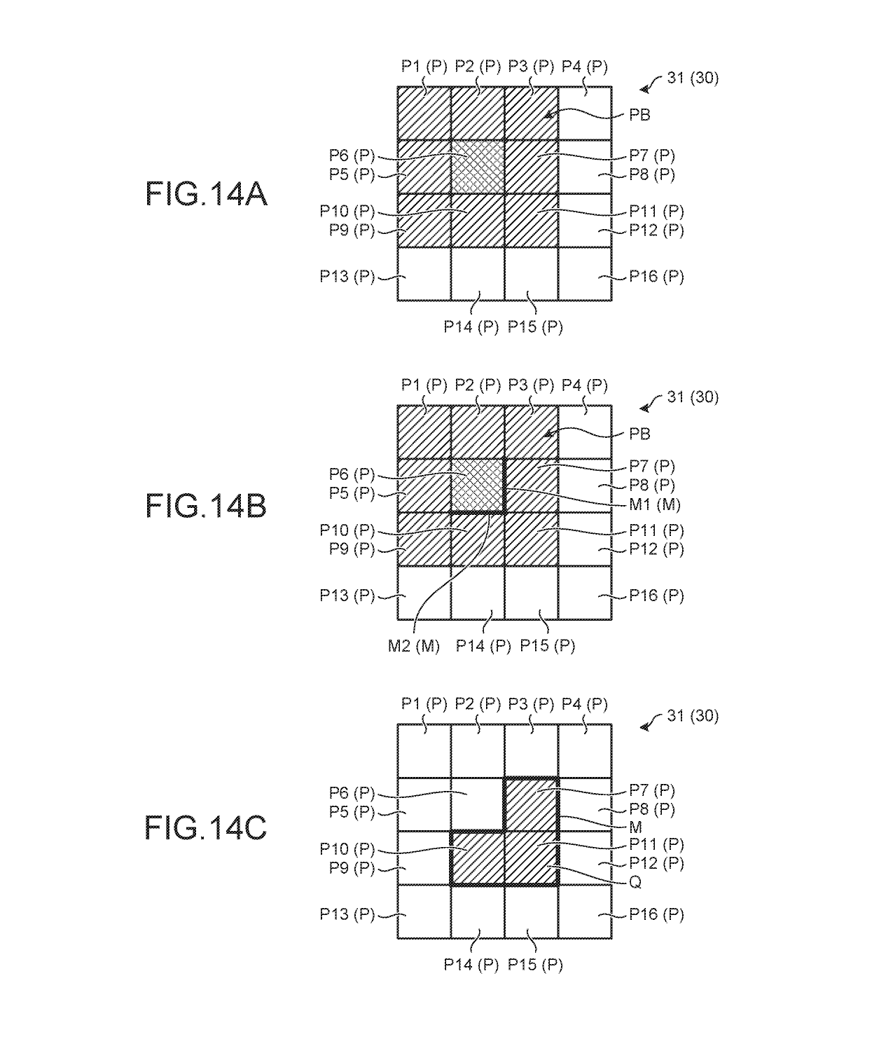

FIGS. 14A to 14C are explanatory views of detection of the attention region Q using the boundary.

In a third modification, the computation unit 12C calculates, as the first density relative value, a group of second density relative values of the density in the first region with respect to the respective densities in the second regions that are included in the surrounding region PB of the region P set as the first region and adjacent to the first region.

FIG. 14A is a schematic diagram illustrating an example of the density distribution 31 calculated by the first calculation unit 12B. FIG. 14A illustrates that the computation unit 12C sets the region P6 as the first region. In this case, the surrounding region PB of the region P1 includes, as the second regions, the regions P1 to P3, the regions P5 and P7, and the regions P9 to P11, which are arranged in contact with the region P6, for example.

In the third modification, the computation unit 12C calculates the relative values of the density (second density relative values) of the region P6 with respect to the respective densities in the second regions (the regions P1 to P3, the regions P5 and P7, and the regions P9 to P11) adjacent to the region P6. In this case, the computation unit 12C calculates eight second density relative values for the region P6 serving as the first region. The group of the eight second density relative values is used as the first density relative value serving as the density in the surrounding region PB.

The detection unit 12D sets the boundary between the first and the second regions used for the calculation of the second density relative value when the second density relative value is larger or smaller than the first threshold.

For example, as illustrated in FIG. 14B, the second density relative value of the region P6 serving as the first region with respect to the region P7 is assumed to be larger than the first threshold. In this case, the detection unit 12D sets a boundary M1 between the regions P6 and P7.

Likewise, the second density relative value of the region P6 serving as the first region with respect to the region P10 is assumed to be larger than the first threshold. In this case, the detection unit 12D sets a boundary M2 between the regions P6 and P10.

In the same manner as described above, the computation unit 12C sequentially sets the respective regions P (regions P1 to P16) included in the image 30 as the first region, and. the detection unit 12D sets a boundary M every time the computation unit 12C calculates the group of the second density relative values of the first region.

The detection unit 12D may detect, as the attention region Q, the regions inside or outside a virtual line indicated by the continuous boundary M out of the regions P included in the image 30.

For example, as illustrated in FIG. 14C, the detection unit 12D may detect, as the attention region Q, the regions inside the (endless) closed virtual line indicated by the continuous boundary M. The end of the virtual line indicated by the continuous boundary M reaches the periphery of the image 30 in some cases. In this case, the detection unit 12D may detect, as the attention region Q, the regions inside the virtual line indicated by the continuous boundary M and the periphery of the image 30.

### Second Embodiment

In a second embodiment, a density relative value (a third density relative value) calculated from predicted density information is used as the first threshold.

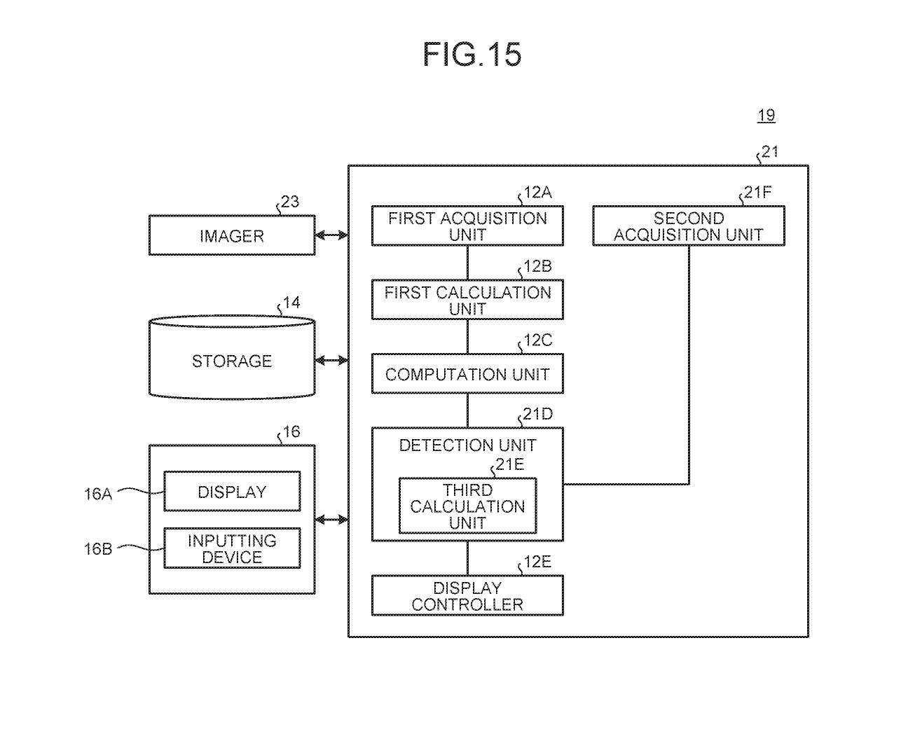

FIG. 15 is a block diagram illustrating an image processing apparatus 19 in the second embodiment.

The image processing apparatus 19 includes a controller 21, the storage 14, the UI unit 16, and the imager 23. The imager 23, the storage 14, and the UI unit 16 are electrically connected to the controller 21.

The imager 23 and the UT unit 16 are the same as those in the first embodiment. The storage 14 stores therein various types of data.

The controller 21 is a computer including a CPU, a ROM, and a RAM, for example. The controller 21 may be a circuit other than the CPU.

The controller 21 controls the whole of the image processing apparatus 19. The controller 21 includes the first acquisition unit 12A, the first calculation unit 12B, the computation unit 12C, a detection unit 21D, the display controller 12E, and a second acquisition unit 21F.

A part or the whole of the first acquisition unit 12A, the first calculation unit 12B, the computation unit 12C, the detection unit 21D, the display controller 12E, and the second acquisition unit 21F may be implemented by causing a processing unit such as a CPU to execute a program, that is, by software, hardware such as an IC, or by both of software and hardware.

The first acquisition unit 12A, the first calculation unit 12B, and the display controller 12E are the same as those in the first embodiment.

The first acquisition unit 12A acquires the image 30. The first calculation unit 12B calculates, for each of the regions P obtained by dividing the image 30, the density of the objects captured in the region P. The computation unit 12C calculates, for each region P, the first density relative value with respect to the density of the objects in the surrounding region PB of the region P.

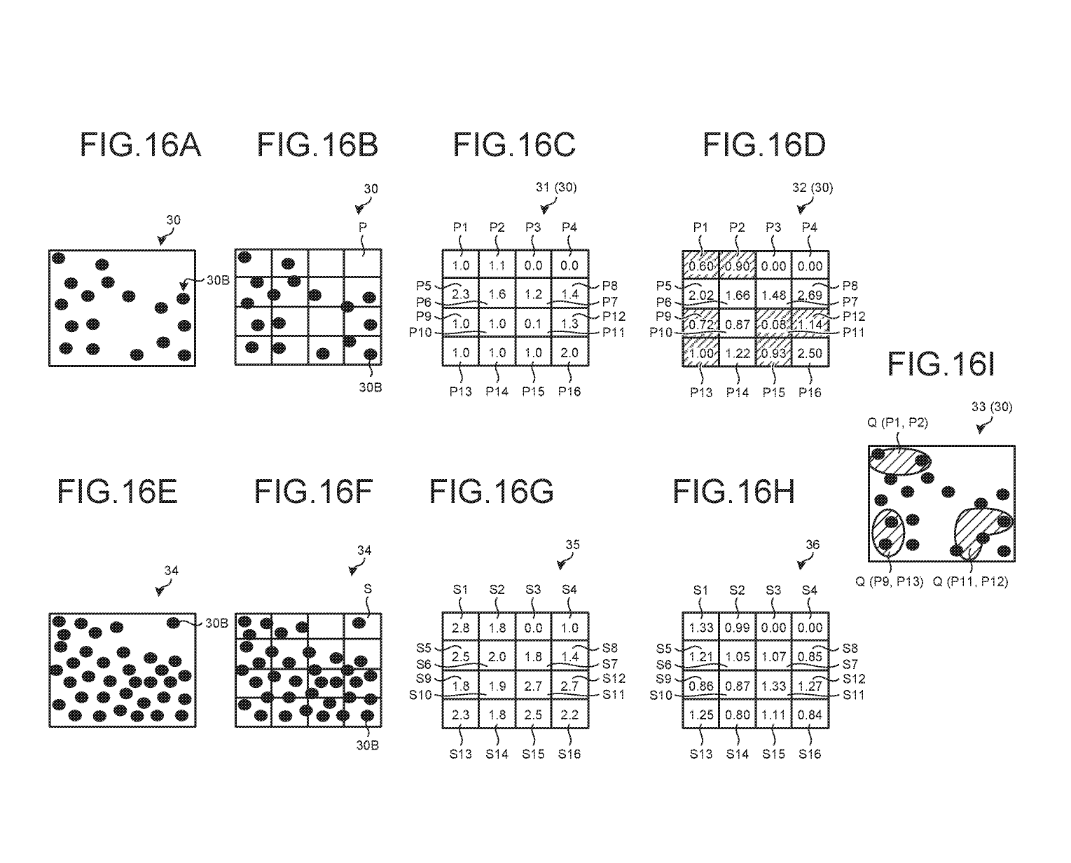

FIGS. 16A to 16I are schematic diagrams illustrating a flow of the processing performed on the image 30. The first acquisition unit 12A acquires the image 30 illustrated in FIG. 16A, for example. The first calculation unit 125 divides the image 30 into the multiple regions P. FIG. 16B illustrates the case where the first calculation unit 12B divides the image 30 into a matrix of 4×4 regions P, that is, 16 regions P in total.

The first calculation unit 12B calculates, for each region P, the density of the persons 30B. FIG. 16C illustrates an example of the density distribution 31. As illustrated in FIG. 16C, the first calculation unit 12B calculates, for each of the regions P1 to P16, the density of the persons 30B captured in the region P. As a result, the first calculation unit 12B obtains the density distribution 31.

The computation unit 12C calculates, for each region P, the first density relative value with respect to the density of the objects in the surrounding region PB of the region P. FIG. 16D is a schematic diagram illustrating an example of the relative value distribution 32 in which the first density relative value is specified for each region P. The computation unit 12C calculates, for each region P, the first density relative distribution using the density distribution 31, to as to produce the relative value distribution 32. The calculation method of the first density relative value is described in the first embodiment, and the description thereof is, thus, omitted.

Referring back to FIG. 15, the controller 21 includes the second acquisition unit 21F in the embodiment. The second acquisition unit 21F acquires an imaging environment of the image 30 used for detecting the attention region Q. The imaging environment means the environment at a time when the image 30 is taken. Examples of the imaging environment include a time when the image is taken, a day of the week when the image is taken, a weather when the image is taken, a type of an event held in the imaging region when the image is taken.

The second acquisition unit 21F may acquire the imaging environment from the UI unit 16. For example, the user inputs the imaging environment of the image 30 used for detecting the attention region Q by operating the UI unit 16.

The display controller 12E displays, on the display 16A, a selection screen that indicates a list of the imaging environments, for example. The user may select a desired imaging environment from the displayed selection screen by operating the inputting device 16B. As a result, the second acquisition unit 21F acquires the imaging environment from the UI unit 16.

The second acquisition unit 21F may acquire the imaging environment of the image 30 by performing image analysis on the image 30 used for detecting the attention region Q, which image 30 is acquired by the first acquisition unit 12A. For example, the storage 14 preliminarily stores therein the imaging environment and a feature amount that indicates the imaging environment obtained by the image analysis of the image 30 in association with each other. The second acquisition unit 21F may calculate the feature amount by the image analysis of the image 30, and acquire the imaging environment of the image 30 by reading the imaging environment corresponding to the calculated feature amount from the storage 14.

In the embodiment, the detection unit 21D is included instead of the detection unit 12D (refer to FIG. 1). The detection unit 21D detects, as the attention region Q, the region P having the first density relative value larger than the predetermined first threshold or smaller than the first threshold, out of the multiple regions P included in the image 30 in the same manner as the detection unit 12D in the first embodiment.

In the embodiment, the detection unit 21D uses, as the first threshold, the third density relative value calculated from the predicted density information.

The predicted density information is information in which a predicted density in each of the regions P included in the image 30 is preliminarily specified. The predicted density information is preliminarily specified and preliminarily stored in the storage 14.

The predicted density in each region P preliminarily specified in the predicted density information may be preliminarily set by the user or preliminarily calculated by the controller 21.

When preliminarily setting the predicted density, the user estimates the density distribution of the objects in the imaging region of the image 30 from the past observation results, for example. The user, thus, estimates the predicted density for each region P and inputs the estimation result as an instruction by operating the UI unit 16. The controller 21 may preliminarily store the predicted density in each region P received from the UI unit 16 in the storage 14 as the predicted density information.

When the controller 21 calculates the predicted density for each region P, the first calculation unit 12B may preliminarily calculate the density for each region P in the same manner as the image processing apparatus 10 in the first embodiment, for example. The first calculation unit 12B calculates the density of the objects in each region P for each of the images 30 taken by the imager 23 for a certain time period (e.g., for a several months or one year). The division condition and the object class may be the same as those used by the first calculation unit 12B in the image processing for detecting the attention region Q.

The first calculation unit 12B specifies the average of the respective densities in the regions P calculated for each of the images 30 taken by the imager 23 for a certain time period as an estimated density value. In this manner, The first calculation unit 12B preliminarily produces the predicted density information using the estimated density values. The first calculation unit 12B may preliminarily store the produced predicted density information in the storage 14 in association with the imaging environment.

When the density calculated by the first calculation unit 12B in the image processing for detecting the attention region Q is the dispersion degree of the objects in the region Q, the density specified for each region P in the predicted density information may be the dispersion degree of the objects.

FIGS. 16E to 16H are schematic diagrams illustrating a flow of the calculation of the predicted density information. For example, the image used for calculating the predicted density information is assumed to be an image 34 illustrated in FIG. 16E. In this case, the first calculation unit 12B divides the image 34 into a plurality of third regions S (refer to FIG. 16F) by the same division condition as the regions P (refer to FIG. 16B).

The first calculation unit 12B calculates, for each third region S, the density of the persons 30B to calculate the predicted density information. FIG. 16G is a schematic diagram illustrating an example of predicted density information 35. As illustrated in FIG. 16G, the first calculation unit 12B calculates, for each of the third regions S, that is, the third regions S1 to S16, the density of the persons 30B captured in the third region S. As a result, the first calculation unit 12B obtains the predicted density information 35.

As described above, the controller 21 preliminarily produces the predicted density information 35 and preliminarily stores the produced predicted density information 35 in the storage 14. The controller 21 preferably produces the predicted density information 35 for each imaging environment and preliminarily stores the produced predicted density information 35 in the storage 14 in association with the imaging environment. In this case, the controller 21 may preliminarily calculate the predicted density information 35 from the images 30 taken under the corresponding imaging environment and preliminarily store the produced predicted density information 35 in the storage 14 in association with the imaging environment.

Referring back to FIG. 15, the detection unit 21D detects the attention region Q using, as the first threshold, the third density relative value calculated from the predicted density information 35.

Specifically, the detection unit 21D includes a third calculation unit 21E. The third calculation unit 21E reads, from the storage 14, the predicted density information 35 corresponding to the imaging environment acquired by the second acquisition unit 21F. When only one type of the predicted density information 35 is stored in the storage 14, the third calculation unit 21E may read the predicted density information 35 stored in the storage 14 regardless of the imaging environment acquired by the second acquisition unit 21F.

The third calculation unit 21E calculates, for each third region S in the read predicted density information 35, the third density relative value with respect to the density of the objects (persons 30B) in a third surrounding region, which is the surrounding region of the third region S. The third calculation unit 21E may calculate, for each third region S, the third density relative value in the same manner as the calculation of the first density relative value by the computation unit 12C.

FIG. 16H is a schematic diagram illustrating an example of a relative value distribution 36 in which the third density relative value is specified for each third region S. The third calculation unit 21E calculates, for each third region S, the third density relative distribution using the predicted density information 35 to produce the relative value distribution 36.

The detection unit 21D detects, as the attention region Q, the region P having the first density relative value larger than the first threshold or smaller than the first threshold, out of the multiple regions P included in the image 30 that is the target for detecting the attention region Q.

In the embodiment, the detection unit 21D uses, for each region P in the image 30, the third density relative value of the corresponding third region S in the predicted density information 35 as the first threshold for the region P.

Specifically, as illustrated in FIG. 16D, the first density relative value is specified for each region P in the relative value distribution 32 produced by the computation unit 12C. In the relative value distribution 36 calculated by the third calculation unit 21E from the predicted density information 35 (refer to FIG. 16G), the third density relative value is specified for each third region S.

The detection unit 21D uses, as the first thresholds for the respective regions P1 to P16 in the relative value distribution 32, the third density relative values in the third regions S1 to S16 arranged at the corresponding positions in the relative value distribution 36. Specifically, the third density relative value of the third region S1 is used for the first threshold for the region P1, for example. Likewise, the respective third density relative values of the third regions S2 to S16 corresponding to the regions P2 to P16, respectively, are used as the respective first thresholds for the regions P2 to P16.

The detection unit 21D detects, as the attention region Q, the region P having the first density relative value larger than the first threshold (the third density relative value) or smaller than the first threshold (the third density relative value), out of the multiple regions P included in the image 30.

In the example illustrated in FIGS. 16A to 16I, the detection unit 21D detects, as the attention regions Q, the regions P1, P2, P9, P11 to P13, and P15 (refer to FIGS. 16D, 16H, and 16I), each of which has the first density relative value smaller than the first threshold.

The display controller 12E displays, on the display 16A, the attention regions Q detected by the detection unit 21D in the same manner as the first embodiment. On the display 16A, the display image 33 is displayed that indicates the regions P1, P2, P9, P11 to P13, and P15 as the attention regions Q (refer to FIG. 16I), for example.

The following describes a procedure of the image processing performed by the image processing apparatus 19 in the embodiment.

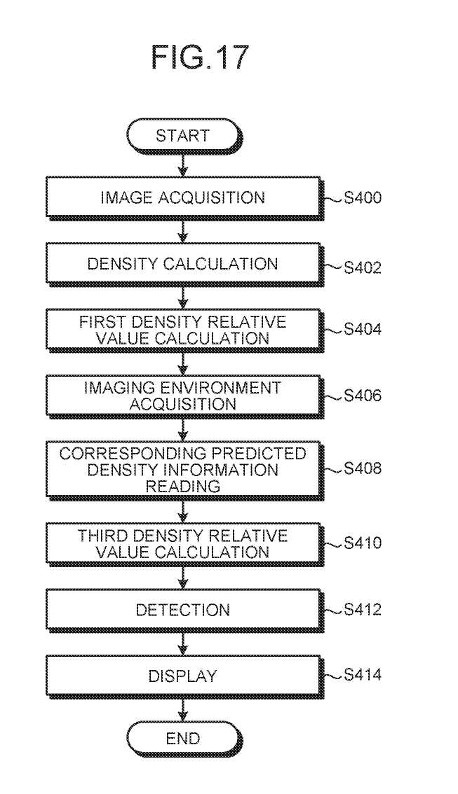

FIG. 17 is a flowchart illustrating an exemplary procedure of the image processing performed by the image processing apparatus 19 in the embodiment.

The first acquisition unit 12A acquires the image 30 that is the target for detecting the attention region Q (step S400). The first calculation unit 12B calculates the density of the objects (persons 30B) captured in each of the regions P obtained by dividing the image 30 acquired at step S400 (step S402).

The computation unit 12C calculates, for each region P, the first density relative value with respect to the density of the persons 30B in the surrounding region PB of the region P (step S404). The second acquisition unit 21F acquires the imaging environment (step S406). The third calculation unit 21E reads, from the storage 14, the predicted density information 35 corresponding to the imaging environment acquired at step S406 (step S408).

The third calculation unit 21E calculates the third density relative value for each third region S in the predicted density information 35 read at step S408 (step S410). The detection unit 21D detects the attention region Q (step S412). The display controller 12E displays the attention region Q on the display 16A (step S414). Then, this routine ends.

As described above, the image processing apparatus 19 according to the embodiment detects the attention region Q using, as the first threshold, the third density relative value calculated by the detection unit 21D from the predicted density information 35.

Thus, the image processing apparatus 19 according to the embodiment can detect, as the attention region Q, the region P where the density differs from that in the surrounding region PB and differs from the predicted density.

For example, it is predicted that the density of the persons 30B in a region where no person is usually present (e.g., on a roadway) is always lower than that in the surrounding region PB. Thus, it is preferable that such a region be not detected as the attention region Q. In the embodiment, the attention region Q is detected using both of She first density relative value of the region P and the predicted density information. The region where the density is usually low and the region where the density is usually high, thus, can be excluded from the attention region Q.

The image processing apparatus 19 according to the embodiment, thus, can detect the attention region Q more correctly.

The image processing apparatus 19 may sequentially store, in the storage 14, the attention regions Q detected using the predicted density information 35 corresponding to the imaging environments acquired by the second acquisition unit 21F in association with the acquired imaging environments. The display controller 12E may display, on the display 16A, the selection screen that indicates a list of the imaging environments. When the user selects a desired imaging environment from the displayed selection screen by operating the inputting device 16B, the display controller 12E may read, from the storage 14, the attention region Q corresponding to the selected imaging environment and display the display image indicating the attention region Q on the display 16A.

In this case, the image processing apparatus 19 can display the detected attention region Q in a switching manner in accordance with the imaging environment selected by the user.

The detection unit 21D may change the determination criterion for detecting the attention region Q in accordance with the imaging environment acquired by the second acquisition unit 21F. In this case, the detection unit 21D may preliminarily store therein the imaging environment and the determination criterion in association with each other. The detection unit 21D may detect the attention region Q using the determination criterion corresponding to the imaging environment acquired by the second acquisition unit 21F.

Specifically, the detection unit 21D may change whether the detection unit 21D detects, as the attention region Q out of the regions P included in the image 30, the region P having the first density relative value larger than the first threshold (the third density relative value) or the region P having the first density relative value smaller than the first threshold (the third density relative value), in accordance with the imaging environment acquired by the second acquisition unit 21F.

For example, when the imaging environment is an “intersection with a red light”, the detection unit 21D detects, as the attention region Q, the region P having the first density relative value smaller than the first threshold. (the third density relative value). When the imaging environment is an “intersection with a green light”, the detection unit 21D detects, as the attention region Q, the region P having the first density relative value larger than the first threshold (the third density relative value).

In this case, the detection unit 21D can detect, as the attention region Q, the region P where a person who is passing through the intersection ignoring the traffic light is present when the imaging environment is the “intersection with a red light”. The detection unit 21D can detect, as the attention region Q, the region P where the obstacle that prevents a person from passing through the intersection is present when the imaging environment is the “intersection with a green light”.

### Third Embodiment

In the first and the second embodiments and the modifications, a single class of object is captured in the image 30. In a third embodiment, a plurality of object classes are captured in the image 30. In the third embodiment, the attention region Q is detected for each object class.

The class means the classification done according to a predetermined rule. The objects of a particular class are objects classified into that classification (i.e., that class). The predetermined rule represents one or more features used in distinguishing the objects from one another by analyzing the taken image in which the objects are captured. Examples of the predetermined rule include colors, shapes, and movements. The object classes differ at least in color and shape from one another, for example.

Examples of the object class include living beings such as humans and non-living materials such as vehicles. The object class may be further classified living beings and more classified non-living materials. For example, the class may be a personal attributes such as the age, gender, and nationality. The class may be a group (a family or a couple) that can be estimated from the relational distance among persons.

In the embodiment, the objects are persons and vehicles, as an example. In the embodiment, the objects captured in the image that is the target for detecting the attention region Q are of the object classes of persons and vehicles, as an example. The objects and the object classes are, however, not limited to persons and vehicles.

In this case, the image processing apparatus 10 can accurately calculate, for each region P, the density of each object class captured in the image 30 by employing the first calculation unit 12B structured as described below. The detection unit 12D of the image processing apparatus 10 detects the attention region Q using the density calculated for each object class. The image processing apparatus 10 in the embodiment, thus, can accurately detect the attention region Q in the image 30 for each object class.

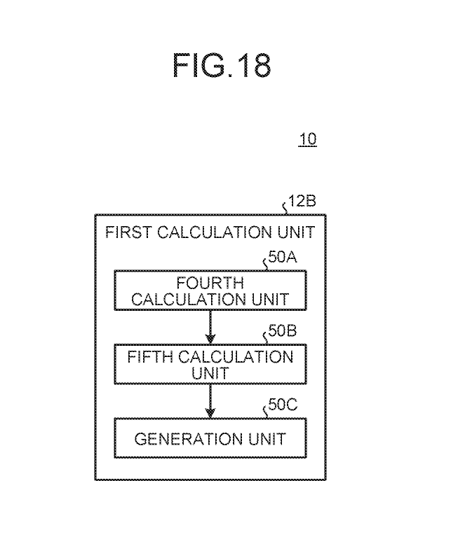

FIG. 18 is a block diagram illustrating the first calculation unit 12B in the image processing apparatus 10 in the embodiment.

The first calculation unit 12B includes a fourth calculation unit 50A, a fifth calculation unit 50B, and a generation unit 50G.

The fourth calculation unit 50A calculates a provisional density of each object class captured in the region P for each of the regions P obtained by dividing the image 30 acquired by the first acquisition unit 12A (refer to FIG. 1). The provisional density is a density provisionally calculated.

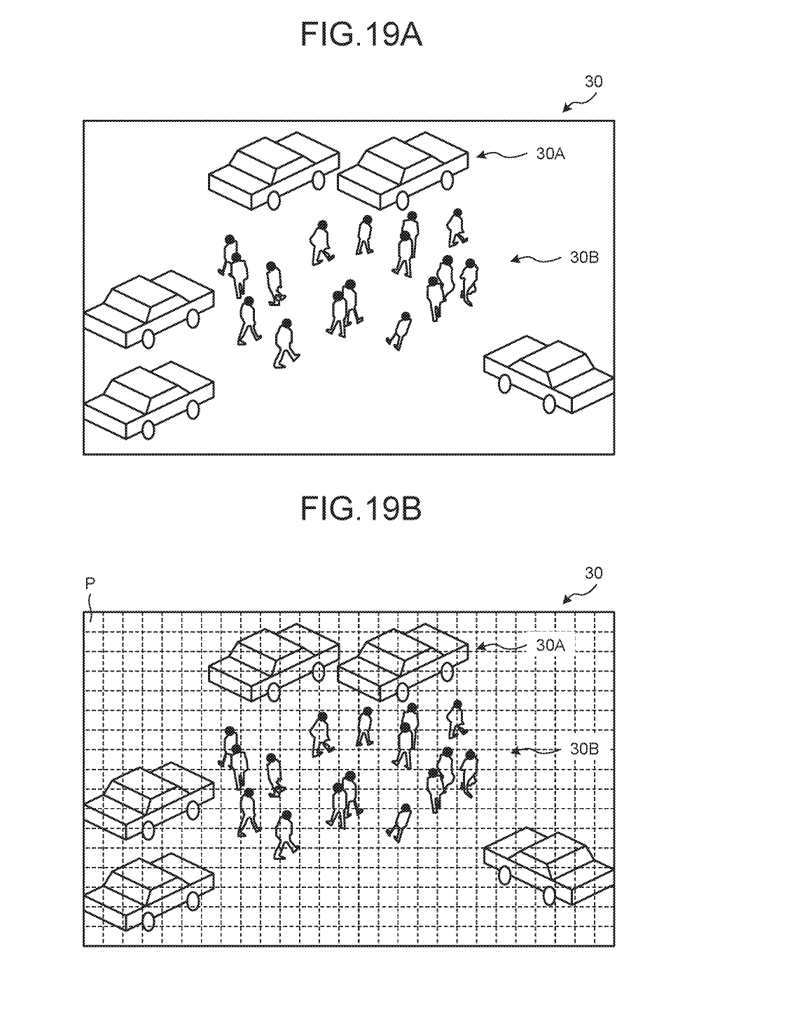

FIGS. 19A and 19B are diagrams illustrating an example of the image 30 used in the embodiment. In the embodiment, the first acquisition unit 12A acquires the image 30 in which vehicles 30A and the persons 30B are captured as the object classes (refer to FIG. 19A).

FIG. 19B is a schematic diagram illustrating a plurality of regions P obtained by dividing the image 30. The fourth calculation unit 50A divides the image 30 into the multiple regions P. The region 30 is divided in the same manner as the first embodiment.

The fourth calculation unit 50A calculates the provisional density of each object class captured in each region P. The provisional density may be calculated in the same manner as the calculation of the density by the first calculation unit 12B in the first embodiment or using a know manner. It is preferable that the fourth calculation unit 50A calculate the provisional density for each object class captured in each region P using a calculation method in a fourth embodiment described later in detail from a point of view of increasing an accuracy in provisional density calculation.

When the group (such as a family or a couple) that can be estimated from the relational distance among persons is used for the object captured in the image 30, the fourth calculation unit 50A may use the range where persons belonging to the same group are present in the image 30 as the region occupied by a single object (group). The fourth calculation unit 50A may adjust the number of groups in accordance with an overlapping state of the ranges in the image 30. For example, when the region P corresponding to one fourth of the range of a certain group overlaps with the range of another group, the fourth calculation unit 50A may calculate the density of the certain group as 0.4 groups in the region P.

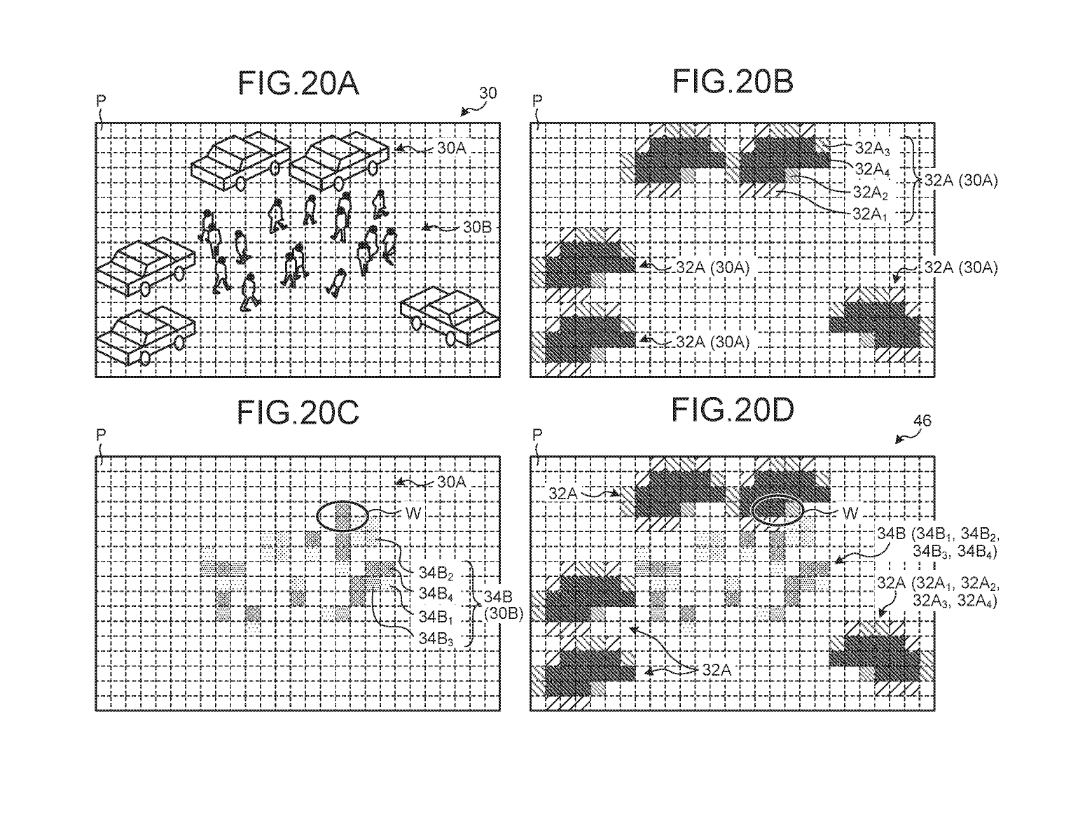

FIGS. 20A to 20D are schematic diagrams illustrating the processing performed on the image 30. The fourth calculation unit 50A calculates the provisional density for each object class captured in each region P in the image 30 illustrated in FIG. 20A, for example. The fourth calculation unit 50A calculates, for each region P, the provisional density of the vehicles 30A captured in the region P and the provisional density of the persons 30B captured in the region P.

FIG. 20B is a diagram illustrating a provisional density 32A of the vehicles 30A calculated for each region P in the image 30. In the example illustrated in FIG. 20B, the provisional densities 32A of the vehicles 30A captured in the regions P are increased from a provisional density 32A₁ toward a provisional density 32A₄. As illustrated in FIG. 20B, the fourth calculation unit 50A calculates the provisional densities 32A (32A₁ to 32A₄) of the vehicles 30A captured in the respective regions P. The values of the provisional densities calculated by the fourth calculation unit 50A are not limited to four level values.

FIG. 20C is a schematic diagram illustrating a provisional density 34B of the persons 30B calculated for each region P in the image 30. In the example illustrated in FIG. 20C, the provisional densities 34B of the persons 30B captured in the regions P are increased from a provisional density 34B₁ toward a provisional density 34B₄. As illustrated in FIG. 20C, the fourth calculation unit 50A. calculates the provisional densities 34B (34B₁ to 34B₄) of the persons 30B captured in the respective regions P.

Referring back to FIG. 18, the fifth calculation unit 50B calculates likelihoods of the object classes captured in each region P from the provisional density of each object class captured in each region P, which provisional density is calculated by the fourth calculation unit 50A. In the embodiment, the likelihood represents the probability of the object class. In the embodiment, the fifth calculation unit 50B calculates the likelihoods, which represent the probabilities, of the object classes captured in each region P from the calculated provisional densities of the object classes.

Specifically, the fifth calculation unit 50B calculates, as the likelihoods of the object classes captured in each region P, multiplication values obtained by multiplying the calculated provisional density of each object class captured in the region P by at least one of an area ratio and a degree of similarity.

For example, the object classes captured in the image 30 are assumed to be the vehicles 30A and the persons 30B. In this case, the fifth calculation unit 50B calculates, for each region P included in the image 30, the likelihood representing the probability of the vehicles 30A and the likelihood representing the probability of the persons 30B.

The area ratio represents a ratio of the area of the objects of each class captured in the image 30 to the area of a reference object. The reference object may be an object having a predetermined size or an object having the smallest area among the object classes captured in the image 30.

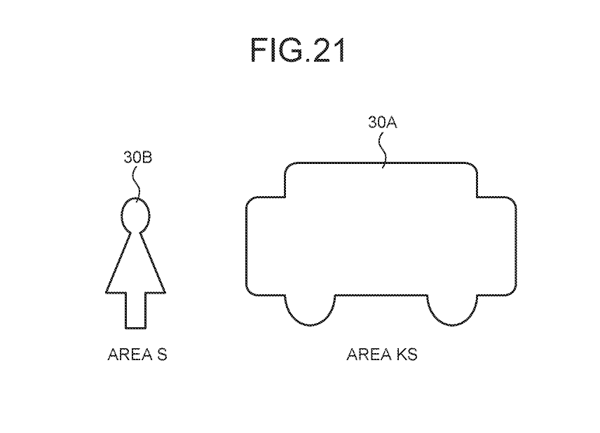

FIG. 21 is an explanatory view of the calculation of the likelihood. For example, the typical area ratio between the person 30B and the vehicle 30A is assumed to be area S:area KS. The reference object is assumed to be the person 30B.

In the embodiment, the “area” represents a mean area of the objects of each class in a two-dimensional image. The area (mean area) of the persons 30B represents the area of the regions including the persons 30B in a taken image in which the entire body of a person 30B having standard proportions is imaged from the front side of the person 30B, for example. The area of the persons 30B may be an average value of the areas of the persons 30B having different proportions. The area (mean area) of the vehicles 30A represents the area of the regions of the vehicles 30A in a taken image in which a vehicle 30A having a standard size is imaged laterally, for example. The photographing scale factor of the taken image of the vehicle 30A is the same as that of the taken image of the person 30B.

When calculating the likelihood using the area, the fifth calculation unit 50B calculates the likelihood of the persons 305 and the likelihood of the vehicles 30A, in each region P, using expressions (1) and (2).

LB(P)=DB(P)×S/S (1)

LA(P)=DA(P)×KS/S (2)

In expression (1), LB(P) represents the likelihood of the persons 30B in the region P and DB(P) represents the provisional density of the persons 30B in the region P. In expression (2), LA(P) represents the likelihood of the vehicles 30A in the region P and DA(P) represents the provisional density of the vehicles 30A in the region P. In expressions (1) and (2), S represents the typical area of the persons 30B (used for the reference region, here) and KS represents the typical area of the vehicles 30A. Thus, S/S represents the area ratio of the persons 30B to the area (in this case, the mean area of the persons 30B as an example) of the reference object. KS/S represents the area ratio of the vehicles 30A to the area (in this case, the area of the persons 30B) of the reference object.

The fifth calculation unit 50B may preliminarily store therein a value (area S: area KS) indicating the typical area ratio between the persons 30B and the vehicles 30A. When calculating the likelihood, the fifth calculation unit 50B may use the area ratio.

The fifth calculation unit 50B preliminarily stores, in the storage 14, the mean area of the objects of each class possibly captured in the image 30. The fifth calculation unit 50B may read, from the storage 14, the mean area corresponding to the class captured in the image 30 to use the read mean area for calculation of the likelihood.

The “degree of similarity” means that the degree of similarity in features with respect to the standard features of the objects of each class (reference features). The larger (higher) value of the degree of similarity indicates that the features are more similar. A feature is a value that represents characteristic elements of the objects of class, for example. Examples of the features include colors and shapes. As for the colors used for the features, a color histogram may be used, for example.

The storage 14 preliminarily stores therein, the value that represents the feature of the objects of each class, for example. For example, when a certain object has a. characteristic color, the storage 14 preliminarily stores therein the characteristic color of the object class as the reference feature of the object. For another example, when a certain object has a characteristic shape, the storage 14 preliminarily stores therein the characteristic shape of the object class as the reference feature of the object. Those reference features may be preliminarily calculated by the fifth calculation unit 50B and stored in the storage 14, for example. The reference features may be appropriately changeable by the user's operation using the inputting device 16B.

When calculating the likelihood using the degree of similarity, the fifth calculation unit 50B calculates the likelihood of the persons 30B and the likelihood of the vehicles 30A, in each region P, using expressions (3) and (4).

LB(P)=DB(P)×CB (3)

LA(P)=DA(P)×CA (4)

In expression (3), LB(P) represents the likelihood of the persons 30B in the region P and DB(P) represents the provisional density of the persons 30B in the region P. In expression (3), CB represents the degree of similarity between the feature of the persons 30B captured in the region P as the calculation target and the reference feature of the persons 30B.

In expression (4), LA(P) represents the likelihood of the vehicles 30A in the region P and DA(P) represents the provisional density of the vehicles 30A in the region P. In expression (4), CA represents the degree of similarity between the feature of the vehicles 30A captured in the region P as the calculation target and the reference feature of the vehicles 30A.

The fifth calculation unit 503 may calculate the degree of similarity between a feature and the reference feature using a known method. The fifth calculation unit 50B may calculate the degree of similarity in such a manner that the degree of similarity is highest when the reference feature (e.g., the reference feature of the vehicles 30A) and the feature of the objects (e.g., the vehicles 30A) in the region P serving as the likelihood calculation target coincide with each other, and the degree of similarity is lowest when the two features totally differ from each other.

When calculating the likelihood using both of the area and the degree of similarity, the fifth calculation unit 50B may calculate, as the likelihood, the multiplication result of multiplying the area ratio and the degree of similarity by the provisional density of each object class captured in the region P. When the degree of similarity is of a plurality of classes (e.g., colors and shapes), the multiplication result of multiplying the area ratio and the degree of similarity of each class by the provisional density of each object class captured in the region P may be calculated as the likelihood.

By performing the processing described above, the fifth calculation unit 50B calculates, for each region P in the image 30, the likelihood of the objects of each class (the vehicle 30A and the person 30B). In the embodiment, the fifth calculation unit 50B calculates the likelihood of the vehicles 30A captured in each region P and the likelihood of the persons 30B captured in each region P.

Referring back to FIG. 18, the generation unit 50C produces density data. In the density data, the provisional density of the object class having the likelihood at least higher than the lowest likelihood out of the likelihoods of the object classes captured in the corresponding region P is allocated to the position corresponding to each region P in the image 30.

The generation unit 50C determines the provisional density allocated to each region P to be the density of the object class in each region P. The density data specifies the density of the object class for each region P in the image 30.

For example, the fifth calculation unit 50B is assumed to calculate, for each region P, the likelihood of the vehicles 30A and the likelihood of the persons 30B. In this case, the generation unit 50C uses, as the likelihood in the region P, the likelihood higher than the lowest likelihood (in this case, there are two classes of objects, the higher of the two likelihoods) out of the likelihood of the vehicles 30A and the likelihood of the persons 30B calculated for each region P.

For example, the likelihood of the vehicles 30A is assumed to be higher than that of the persons 30B in a certain region P. In this case, the fifth calculation unit 50B uses the likelihood of the vehicles 30A, which is the higher likelihood, as the likelihood in the region P.

The fifth calculation unit 50B allocates, to the position corresponding to the region P in the image 30, the provisional density of the vehicles 30A, which vehicle 30A is the object class having the likelihood used in the region P, as the density of the vehicles 30A in the region P. The allocated provisional density is the provisional density of the vehicles 30A (the provisional density corresponding to the object class having the higher likelihood in the region P), which provisional density is calculated by the fourth calculation unit 50A for the region P.

In contrast, the likelihood of the vehicles 30A is assumed to be lower than that of the persons 30B in a certain region P. In this case, the fifth calculation unit SOB uses the likelihood of the persons 30B, which is the higher likelihood, as the likelihood in the region P.

The fifth calculation unit 50B allocates, to the position corresponding to the region P in the image 30, the provisional density of the persons 30B, which is the object class having the likelihood used in the region P, as the density of the persons 30B in the region P. The allocated provisional density is the provisional density of the persons 30B (the provisional density corresponding to the higher likelihood in the region P) calculated by the fourth calculation unit 50A for the region P.

As described above, the generation unit 50C produces the density data in which the provisional density of the object class having the likelihood at least higher than the lowest likelihood out of the likelihood calculated for each object class captured in the region P is allocated to the position corresponding to each region P in the image 30.

When the likelihood of each region P is calculated for the objects of more than two classes, the generation unit 50C may select the likelihood of any one class other than the class having the lowest likelihood as the likelihood used for the region P.

The generation unit 50C preferably produces the density data in which the provisional density of the object class having the highest likelihood out of the likelihood calculated for each object class in the region P is allocated to the position corresponding to the region P in the image 30.

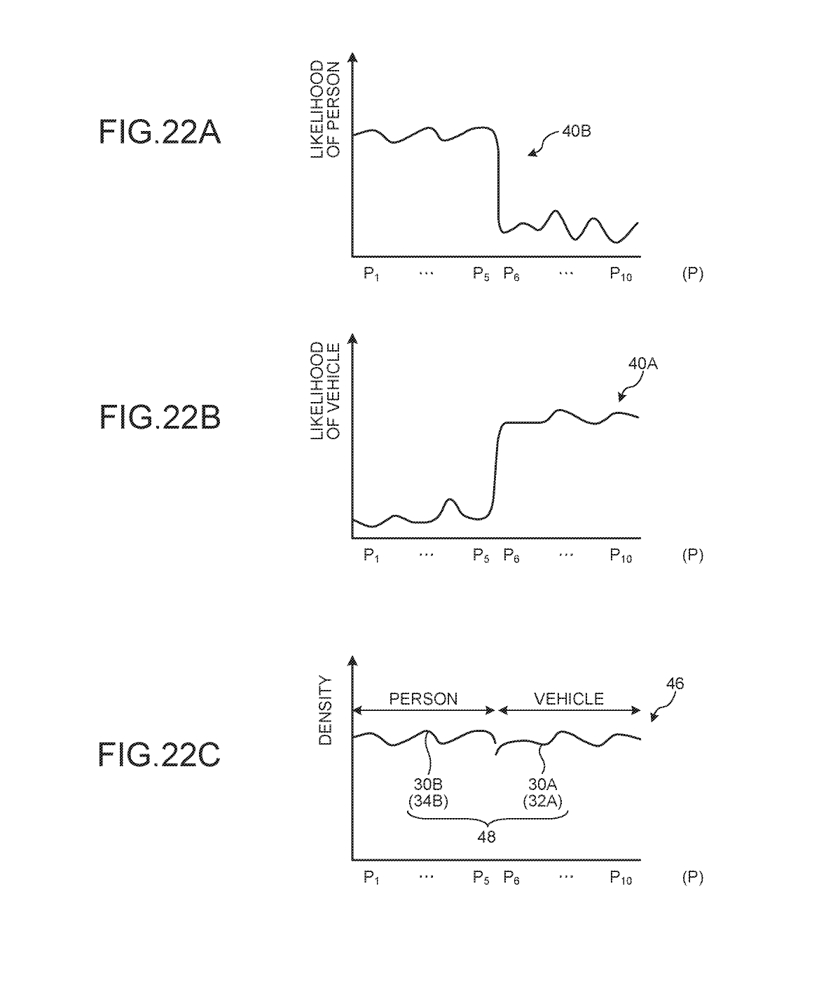

FIGS. 22A to 22C are explanatory views of the production of the density data by the generation unit 50C. For example, the likelihood calculated for each object class in each region P by the fifth calculation unit 50B are assumed to have a relation indicated by a line 40B illustrated in FIG. 22A and by a line 40A illustrated in FIG. 22B.

Specifically, the likelihood of the persons 30B is higher in regions P₁ to P₅ in the image 30 while the likelihood of the persons 30B is lower in regions P₆ to P₁₀ in the image 30 (refer to the line 40B in FIG. 22A). In contrast, the likelihood of the vehicles 30A is lower in the regions P₁ to P₅ in the image 30 while the likelihood of the vehicles 30A is higher in the regions P₆ to P₁₀ in the image 30 (refer to the line 40A in FIG. 22B).

In this case, the generation unit 50C calculates density data 48 illustrated in FIG. 22C by allocating the provisional density according to the likelihood in each region P as the density in the region P. Specifically, the generation unit 50C allocates a provisional density 34B that corresponds to the likelihood of the persons 30B, which is the object class having the higher likelihood in the regions P₁ to P₅, as the density of the persons 30B in the regions P₁ to P₅. The generation unit 50C allocates a provisional density 32A that corresponds to the likelihood of the vehicles 30A, which is the object class having the higher likelihood in the regions P₆ to P₁₀, as the density of the vehicles 30A in the regions P₅ to P₁₀. As a result, the generation unit 50C produces density data 46.

The following further describes the flow of the production of the density data with reference to FIGS. 20A to 20D.

As described above, the fourth calculation unit 50A calculates the provisional density for each object class captured in each region P in the image 30 illustrated in FIG. 20A. As a result, the fourth calculation unit 50A calculates, for each region P, the provisional density 32A of the vehicles 30A (refer to FIG. 20B) and the provisional density 34B of the persons 30B (refer to FIG. 20C).

The provisional density, which is calculated by the fourth calculation unit 50A for each region P, of each object class captured in the region P includes an error in some cases. For example, the provisional density 34B is calculated that indicates the presence of the person 30B in a region W illustrated in FIG. 20C although no person 30B is present but only the vehicle 30A is actually present in the region W, in some cases. The error is due to false determination about the object class, for example.

The image processing apparatus 10 in the embodiment. includes the fifth calculation unit 50B and the generation unit 50C. As described above, the generation unit 50C produces the density data 46 using the likelihood calculated by the fifth calculation unit 50B for each object class captured in each region P.

FIG. 20D is a schematic diagram illustrating an example of the density data 46. In the density data 46, the provisional density of the object class having the likelihood higher than the lowest likelihood in the region P is allocated to the position corresponding to each region P as the density in the region P of the image 30. The density data 46, thus, reduces an error due to false determination about the object class.

Specifically, as illustrated in FIG. 20D, the provisional density 34B of the persons 30B, which is illustrated in FIG. 20C and is calculated by the fourth calculation unit 50A, includes the region W that is erroneously determined that the person 30B is present therein. As the result of the production of the density data on the basis of the likelihood by the generation unit 50C, the provisional density of the vehicles 30A is allocated to the region W in the produced density data 46 as the density in the region W, thereby preventing the density data 46 from the false determination.

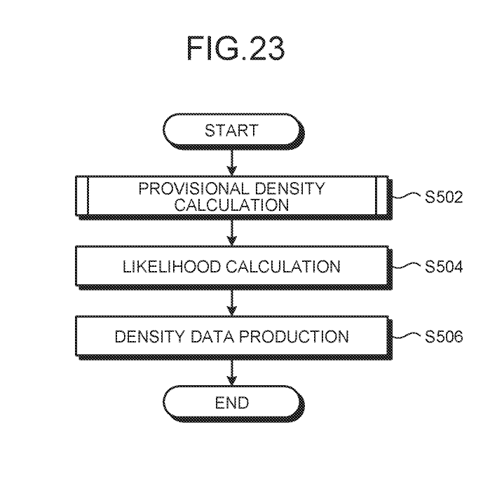

The following describes the processing to produce the density data performed by the first calculation unit 12B in the embodiment. FIG. 23 is a flowchart illustrating a flow of the processing to produce the density data performed by the first calculation unit 12B in the embodiment.

The fourth calculation unit 50A of the first calculation unit 12B calculates the provisional density for each object class captured in the region P for each of the regions P obtained by dividing the image 30 acquired by the first acquisition unit 12A (refer to FIG. 1) (step S502).

The fifth calculation unit 501B calculates the likelihoods of the classes of objects in each region P from the provisional density of each object class in each region P. which provisional density is calculated at step S502 (step S504). The generation unit 50C produces the density data 46 (step S506). Then, this routine ends.

Referring back to FIG. 1, the computation unit 12C calculates, for each region P, the first density relative value for each object class captured in the image 30 using the density (i.e., the density data) calculated for each region P for each object class by the first calculation unit 12B. The computation unit 12C reads, from the density data 46, the density of each region P for each object class captured in the image 30. The computation unit 12C may calculate, for each region P, the first density relative value for each object class in the same manner as the first embodiment.

The detection unit 12D may detect, for each object class, the attention region Q using the first density relative value calculated for each region P in the same manner as the first embodiment.

In the embodiment as described above, the first calculation unit 12B produces the density data 46 using the likelihoods of the classes of objects obtained for each region P in the image 30. The image processing apparatus 10 in the embodiment, thus, can prevent the reduction in the density calculation accuracy caused by the false determination about the object class captured in the image 30.

The detection unit 12D detects, for each object class, the attention region Q using the first density relative value calculated for each region P in the same manner as the first embodiment. The image processing apparatus 10 in the embodiment, thus, can accurately detect the attention region Q for each object class captured in the image 30.

### Fourth Embodiment

In a fourth embodiment, the following describes an example of the provisional density calculation processing performed by the fourth calculation unit 50A in the third embodiment.

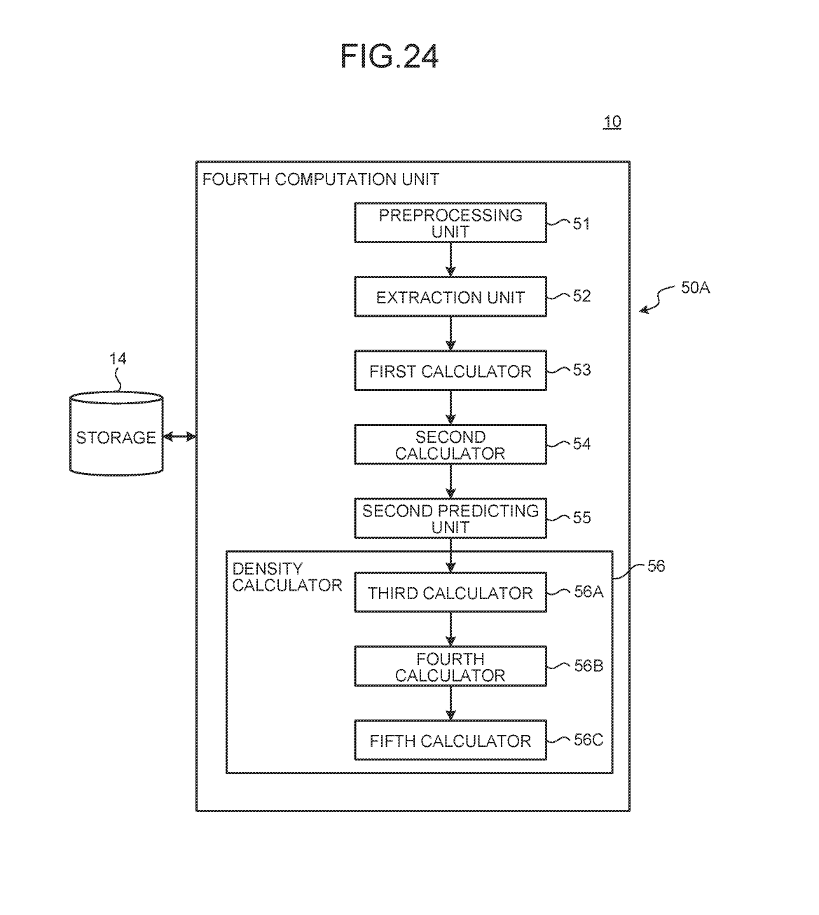

FIG. 24 is a block diagram illustrating an exemplary structure of the fourth calculation unit 50A (refer to FIG. 18) included in the image processing apparatus 10.

The fourth calculation unit 50A includes a preprocessing unit 51, an extraction unit 52, a first calculator 53, a second calculator 54, a second predicting unit 55, and a density calculator 56.

A part or the whole of the preprocessing unit 51, the extraction unit 52, the first calculator 53, the second calculator 54, the second predicting unit 55, and the density calculator 56 may be implemented by causing a processing unit such as a CPU to execute a computer program, that is, by software, hardware such as an IC, or by both of software and hardware.

The fourth calculation unit 50A performs the provisional density calculation processing for each object class. In the calculation processing, the provisional density of each object class captured in the region P is calculated for each region P from the image 30 acquired by the first acquisition unit 12A (refer to FIG. 1).

For example, when the vehicles 30A and the persons 30B are captured in the image 30, the fourth calculation unit 50A performs the density calculation processing to calculate the provisional density of the vehicles 30A captured in each region P of the image 30, and thereafter, performs the provisional density calculation processing to calculate the provisional density of the persons 30B captured in each region P of the image 30.

The preprocessing unit 51 performs preprocessing that includes at least one of reduction processing and correction processing before the calculation processing of the provisional density of each object class. The reduction processing reduces the size of the objects of classes other than the class of the target objects for calculation in the image 30. The correction processing corrects the colors of the object of classes other than the class of the target objects for calculation in the image 30 to a background color. The correction from the color to the background color means that the colors of the regions other than the target objects for calculation in the image 30 are corrected to a color different from the color of the class of the target objects for calculation.

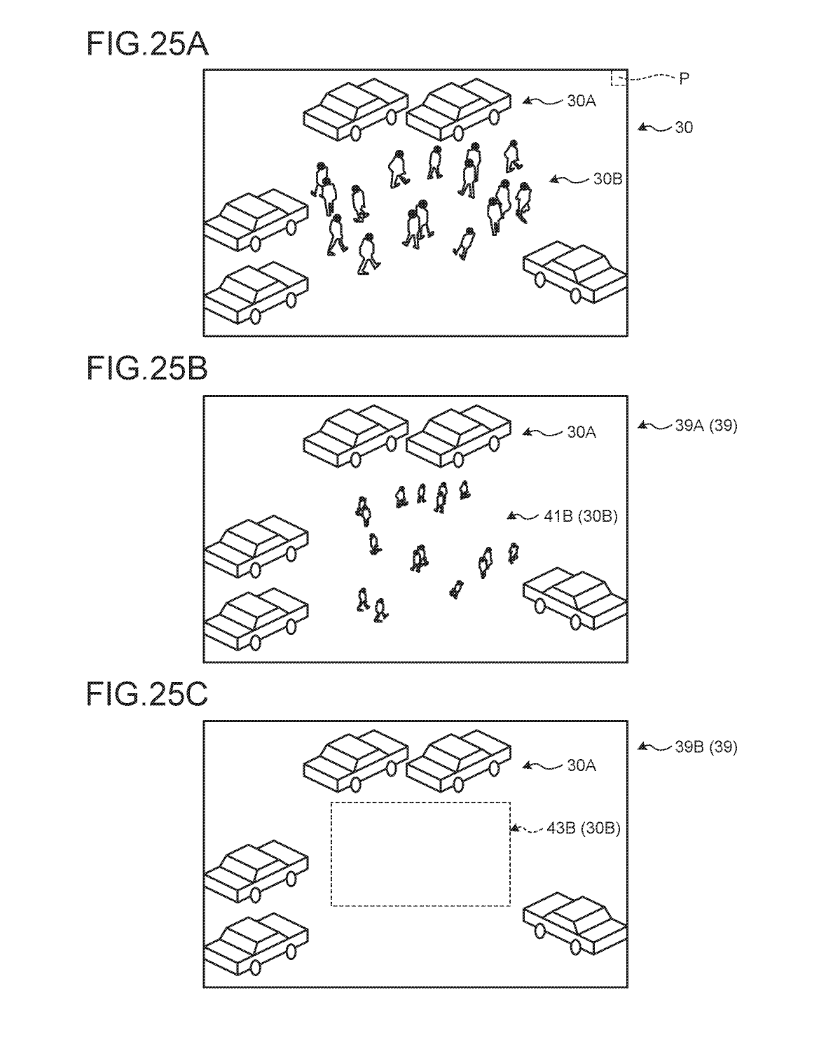

FIGS. 25A to 25C are explanatory views of the preprocessing. The fourth calculation unit 50A is assumed to calculate the provisional densities of the objects for each region P in the image 30 illustrated in FIG. 25A. The image 30 illustrated in FIG. 25A includes the vehicles 30A and the persons 30B in the same manner as the image 30 described in the third embodiment.

The preprocessing unit 51 reduces the sizes of the persons 30B, the object class of which differs from the vehicles 30A, captured in the image 30 (refer to a person region 41B in FIG. 25B) to produce a correction image 39A when the fourth calculation unit 50A calculates the provisional density of the vehicles 30A for each region P.

The preprocessing unit 51 corrects the colors of the persons 30B, the object class of which differs from the vehicles 30A, captured in the image 30 (refer to a person region 43B in FIG. 25C) to the background color to produce a correction image 39B when the fourth calculation unit 50A calculates the provisional density of the vehicles 30A for each region P.

The fourth calculation unit 50A performs the provisional density calculation processing on the vehicles 30A captured in the image 30.

The preprocessing unit 51, then, reduces the sizes of the vehicles 30A, the object class of which differs from the persons 30B, captured in the image 30 to produce the correction image. The preprocessing unit 51, then, corrects the colors of the vehicles 30A, the object class of which differs from the persons 30B, captured in the image 30 to the background color to produce the correction image. The fourth calculation unit 50A performs the provisional density calculation processing on the persons 30B captured in the image 30.

Referring back to FIG. 24, the extraction unit 52, the first calculator 53, the second calculator 54, the second predicting unit 55, and the density calculator 56 perform the processing described later using the correction image 39A or the correction image 39B when the provisional density of the vehicles 30A is calculated for each region P in the image 30. In the following description, the correction images (e.g., the correction image 39A and the correction image 39B) after the correction by the preprocessing unit 51 are collectively described as a correction image 39 (refer to FIGS. 25B and 25C).

The extraction unit 52 extracts a plurality of partial images from the image 30.

The partial image, which is a part of the correction image 39, includes at least a single object. The correction image 39 is an image in which the object/objects of the class/classes other than the class of the target object/objects for calculation is/are reduced in size or has/have the same color as the background color. A partial image, thus, includes at least a single object of the class of target objects for provisional density calculation (e.g., at least the vehicle 30A or the person 30B) captured in the correction image 39.

In this embodiment, a description will be given of the case where the partial image is an image of a part of the correction image 39 extracted in a rectangular shape. Here, the shape of the partial image is not limited to the rectangular shape, and may be any shape.

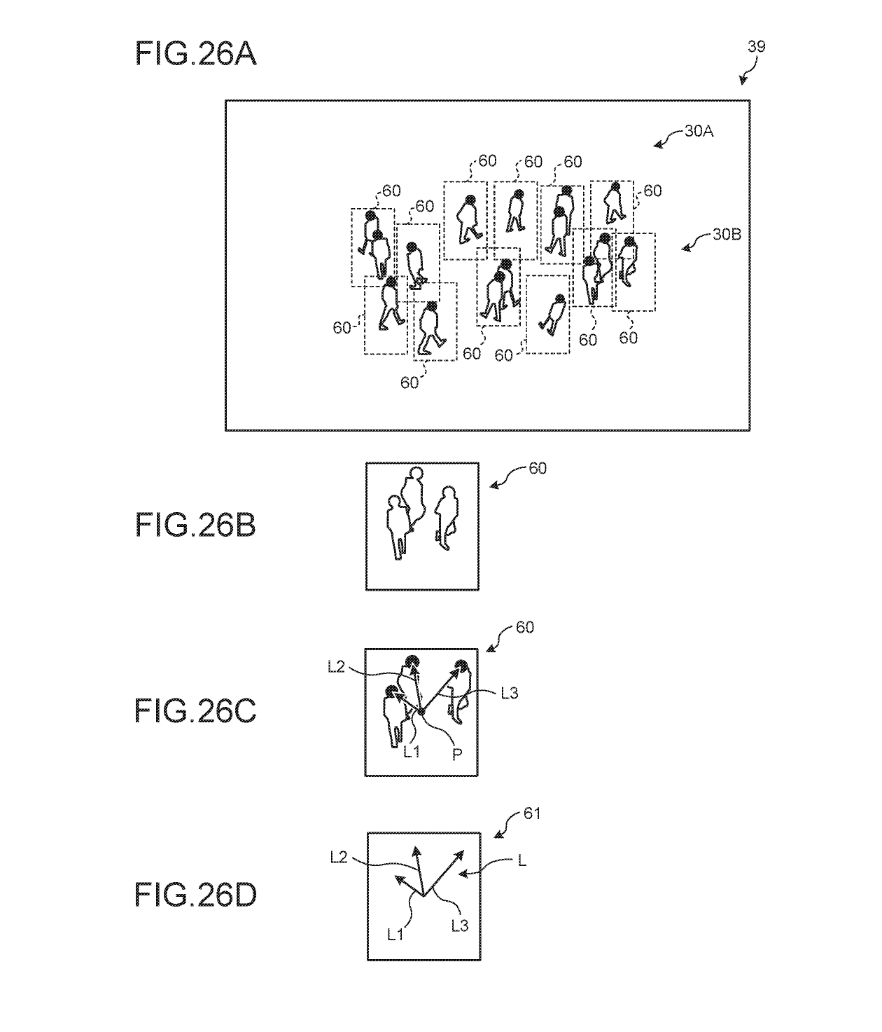

FIGS. 26A to 26D are explanatory diagrams of the correction image 39, partial images 60, and a label 61 (described later in detail).

FIG. 26A is a schematic diagram illustrating an example of the correction image 39. In the correction image 39 illustrated in FIG. 26A, the persons 30B captured in the image 30 represent the class of target objects for provisional density calculation, and the vehicles 30A are corrected to be reduced in size or to have the same color as the background color. FIG. 26B is a schematic diagram illustrating an example of the partial image 60.

The extraction unit 52 extracts the multiple partial images 60 by moving over the rectangular regions serving as the extraction targets in the image 30 (refer to FIG. 26A). The partial images 60 extracted from the image 30 have the same size and shape from one another.

At least a part of the partial images 60 extracted from the correction image 39 may overlap with one another. The number of partial images 60 extracted from the correction image 39 by the extraction unit 52 may be more than one. The number of extracted partial images 60 is preferably a larger number. Specifically, the extraction unit 52 preferably extracts the partial images 60 equal to or larger than 1000 from the correction image 39.

A larger number of partial images 60 extracted by the extraction unit 52 from the correction image 39 enables the fourth calculation unit 50A to better learn a regression model that can calculate the density with high accuracy in the processing described later.

Referring back to FIG. 24, the first calculator 53 calculates respective feature amounts of the plurality of the partial images 60 extracted by the extracting unit 52. The feature amount is the value indicating the feature of the partial image 60. The feature amount employs, for example, the result of discretizing the pixel values of the pixels that constitute the partial image and then one-dimensionally arranging the discretized pixel values or the result of normalizing these one-dimensionally arranged pixel values with the difference (that is, the gradient) from the adjacent pixel value in these one-dimensionally arranged pixel values. Alternatively, the feature amount may employ a SIFT feature (see D. Lowe “, Object recognition from local scale-invariant features,” Int. Conf, Comp. Vision, Vol. 2, pp. 1150-1157, 1999) or similar feature. The SIFT feature is the histogram feature that is strong against a slight change.

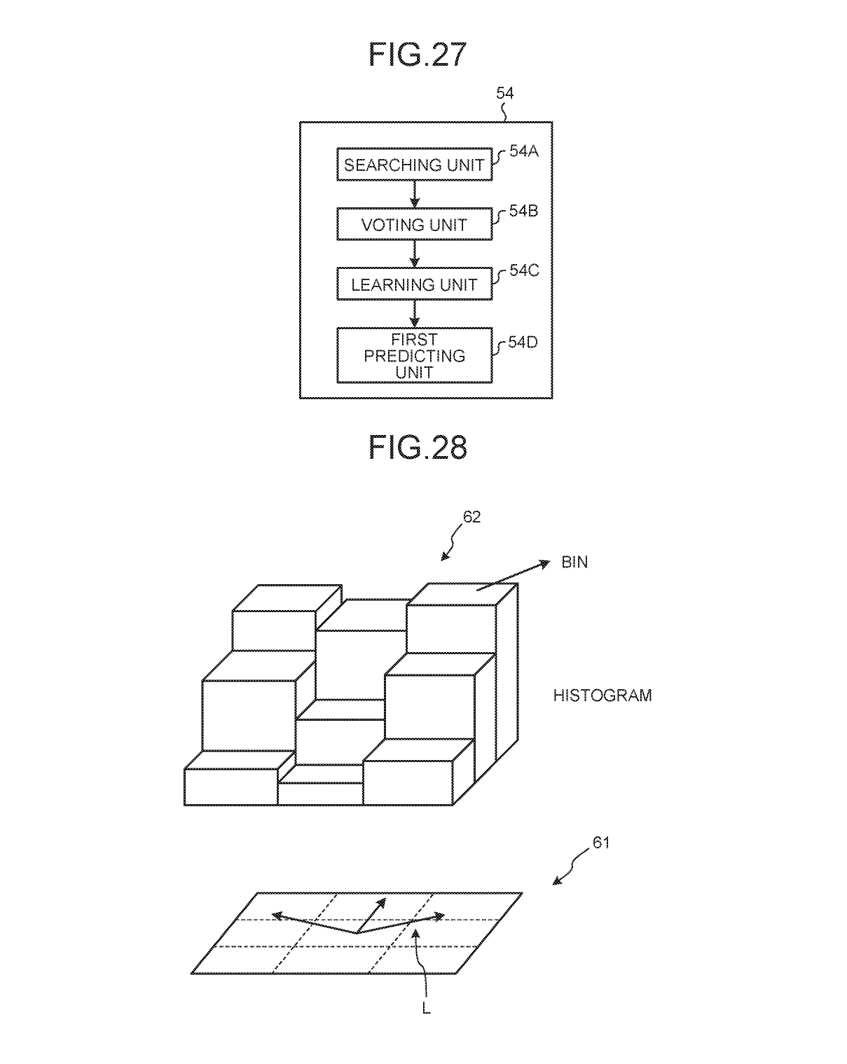

The second calculator 54 calculates a regression model and representative labels. FIG. 27 is a block diagram. illustrating an exemplary structure of the second calculator 54.

The second calculator 54 includes a searching unit 54A, a voting unit 54B, a learning unit 54C, and a first predicting unit 54D. A part or the whole of the searching unit 54A, the voting unit 54B, the learning unit 54C, and the first predicting unit 54D may be implemented by causing a processing unit such as a CPU to execute a computer program, that is, by software, hardware such as an IC, or by both of software and hardware.

The searching unit 54A gives a label to each feature amount of the plurality of the partial images 60. The label represents the relative position between the object included in each partial image 60 and a position in each partial image 60. Specifically, the searching unit 54A firstly retrieves objects included in each of the plurality of the partial images 60 extracted by the extracting unit 52. Subsequently, the searching unit 54A generates, for each partial image 60, a vector representing the relative positions between the first position in the partial image 60 and each of all the objects included in the partial image 60 as a label. Subsequently, the searching unit 54A gives the generated label to the feature amount of the corresponding partial image 60.

The first position only needs to be any predetermined position within the partial image. In this embodiment, the first position will be described as the center position (the center of the partial image 60) in the partial image 60.

Referring back to FIGS. 26A to 26D, FIG. 26C and FIG. 26D are explanatory diagrams of the label 61. For example, the searching unit 54A retrieves objects included in each of the partial images 60 illustrated in FIG. 26B. Subsequently, the searching unit 54A generates vectors L1, L2, and L3 representing the relative positions between a center position P of the partial image 60 and each of all objects (three objects in the example illustrated in FIGS. 26B and 26C) included in the partial image 60 (see FIG. 26C). Subsequently, the searching unit 54A gives a vector L that is a set of these vectors L1, L2, and L3 to the feature amount of the partial image 60 as the label 61 (see FIG. 26D).

Referring back to FIG. 27, the voting unit 54B calculates, for each of the plurality of the partial images 60, a histogram representing the distribution of the relative positions of the objects included in each partial image 60.

FIG. 28 is an explanatory diagram of the label 61 and a histogram 62. As illustrated in FIG. 28, the voting unit 54B calculates the histogram 62 from the label 61.

The histogram 62 is a collection of bins uniformly arranged in the partial image 60. The size of the bin in the histogram 62 is determined according to the relative positions of the objects included in the partial image 60. For example, the size of the bin in a position b in the partial image 60 is expressed by the following formula (5).

B(b)=ΣN(b; oj, σ) (5)

In the formula (5), B(b) denotes the size of the bin in the position b in the partial image 60. Additionally, oj denotes the position of the object. In the formula (5), N(b; oj, σ) is a value of the probability density function for the normal distribution of (the center oj, the dispersion o) in the position b.

Referring back to FIG. 27, subsequently, the voting unit 54B votes each histogram 62 calculated for each of the plurality of the partial images 60 into a parameter space. Accordingly, the voting unit 54B generates, for each of the plurality of the partial images 60, a voting histogram corresponding to each partial image 60.

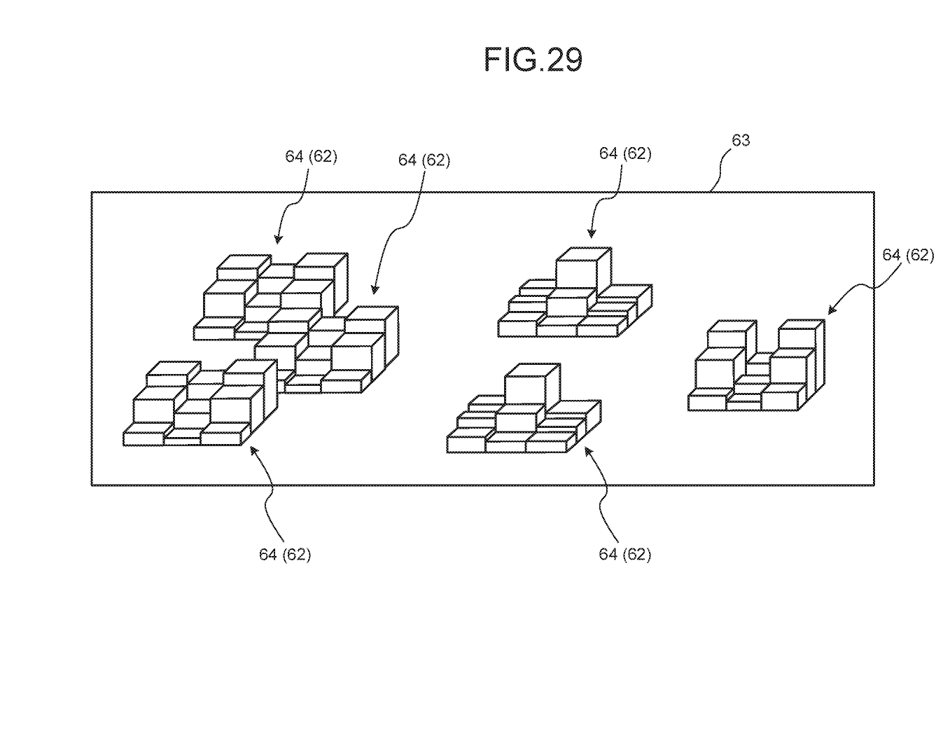

FIG. 29 is an explanatory diagram of the voting histogram 64. The histogram 62 is voted into a parameter space 63 to be a voting histogram 64. In FIG. 29, the parameter space is simply illustrated in two dimensions.

In this embodiment, the parameter space will be described as a three-dimensional parameter space (x, y, s). Here, (x, y) denotes a two-dimensional position (x, y) within the partial image, and (s) denotes a size (s) of the object. The parameter space may be a multi-dimensional parameter space to which the posture of the object, the direction of the object, and similar parameter are added other than the above-described parameters.

Referring back to FIG. 27, the learning unit 54C learns a regression model representing the relation between the feature amount of the partial image 60 and the relative position of the object included in the partial image 60. Specifically, the learning unit 54C divides the feature amount with the label 61 corresponding to each of the plurality of the partial images 60 into a plurality of clusters to reduce the variation of the corresponding voting histogram, so as to learn the regression model.

In this embodiment, a description will be given of the case where the regression model is one or a plurality of random trees. The plurality of random trees is, that is, a random forest. In this embodiment, the cluster means a leaf node that is a node at the end of the random tree.

In this embodiment, learning the regression model by the learning unit 54C means: determining a division index for each of nodes from a root node via child nodes to leaf nodes represented by the random tree, and also determining the feature amount that belongs to the leaf nodes. Here, this feature amount is the feature amount with the label 61 as described above.

In this embodiment, the learning unit 54C determines the division index for each of the nodes from the root node via the child nodes to a plurality of leaf nodes and also determines the feature amount that belongs to each of the plurality of leaf nodes to reduce the variation of the voting histogram 64, so as to learn the regression model.

The learning unit 54C is preferred to learn a plurality of regression models with different combinations of the division indexes. In this embodiment, the learning unit 54C changes the combination of the division indexes for each node so as to learn a predetermined number (hereinafter referred to as T) of regression models.

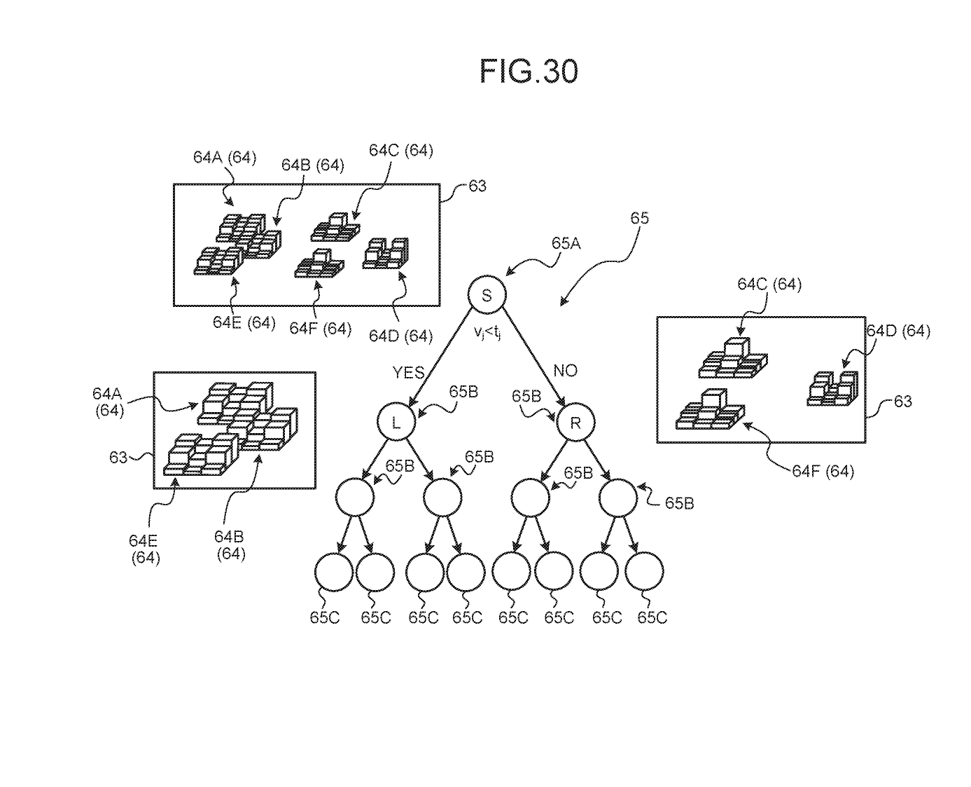

FIG. 30 is an explanatory diagram of the random tree 65.

FIG. 30 illustrates the voting histograms 64 of the parameter space 63 simplified in two dimensions next to the respective nodes. In the example illustrated in FIG. 30, as the voting histograms 64 corresponding to the respective feature amounts for a plurality of the partial images 60, a voting histogram 64A to a voting histogram 64F are illustrated. Hereinafter, the feature amount of the partial image 60 is described as a feature amount v in some cases. As described above, a label is given to this feature amount v.

Firstly, the learning unit 54C allocates all the feature amounts v with the labels calculated by the first calculator 53 and the searching unit 54A to “S” that is a root node 65A.

The learning unit 54C determines the division index when “S” as this root node 65A is divided into “L” and “R” as respective two child nodes 65B. The division index is determined by an element vj of the feature amount v and a threshold value tj of the element vj.

Specifically, the learning unit 54C determines the division index for a division-source node so as to reduce the variation of the voting histogram in a division-destination node (the child node 65B or a leaf node 65C). The division index is determined by the element vj of the feature amount v and the threshold value tj of the element vj.

Particularly, the learning unit 54C determines the division index (hereinafter referred to as a tentative allocation operation) assuming that the feature amount v with the label satisfying the relation of the element vj<the threshold value tj is allocated to “L” as the child node 65B (in the case of yes in FIG. 30) and the feature amount v without satisfying the relation of the element vj<the threshold value tj is allocated to “R” as the child node 65B (in the case of no in FIG. 30).

At this time, the learning unit 54C determines the division index of the feature amount v to reduce the variation of the voting histogram 64. For example, the learning unit 54C determines the division index using the following formula (6).

G=Σ{H(l)−HL)²+Σ(H(r)−HR}² (6)

In the formula (6), H (l) denotes the voting histogram 64 obtained by dividing “S” as the root node 65A into “L” as the child node 65B. In the formula (6), H (r) denotes the voting histogram 64 obtained by dividing “S” as the root node 65A into “R” as the child node 65B. In the formula (6), HL is the average value of all the H (l). Additionally, HR is the average value of all the H (r).

Here, the formula that the learning unit 54C uses for determining the division index is not limited to the formula (6).

The learning unit. 54C determines, for each node, the division index such that the variation of the voting histogram 64 becomes smallest, and then repeats this tentative allocation operation from the root node 65A via the child node 65B to the leaf node 65C. That is, the learning unit 54C determines, for each node, the combination of the element vj and the threshold value tj as the division index such that the value of G becomes smallest in the above-described formula (6), and then repeats dividing the feature amount v that belongs to each node.

Then, the learning unit 54C determines, as the leaf node 65C, the node when the termination condition is satisfied. The termination condition is, for example, at least one of a first condition, a second condition, and a third condition. The first condition is when the number of the feature amounts v included in the node is smaller than a predetermined number. The second condition is when the depth of the tree structure of the random tree 65 is larger than a predetermined value. The third condition is when the value of the division index is smaller than a predetermined value.

With this determination of the leaf node 65C, the learning unit 54C learns the feature amount v that belongs to the leaf node 65C.

As described above, the learning unit 54C determines the division index of each node from the root node 65A via the child node 65B to the leaf node 65C and also determines the feature amount v that belongs to the leaf node 65C, so as to learn the random tree 65. The learning unit 54C changes the combination of the division index and performs the above-described tentative allocation operation so as to learn the predetermined number T of the random trees 65.

The number T of random trees 65 to be learnt by the learning unit 54C may be one or any number equal to or larger than two. As the learning unit 54C learns a larger number of the random trees 65 from the correction image 39, the image processing apparatus 10 can learn the random trees 65 that allows calculating the density with high accuracy. The learning unit 54C preferably learns the random forest, which is the multiple random trees 65.

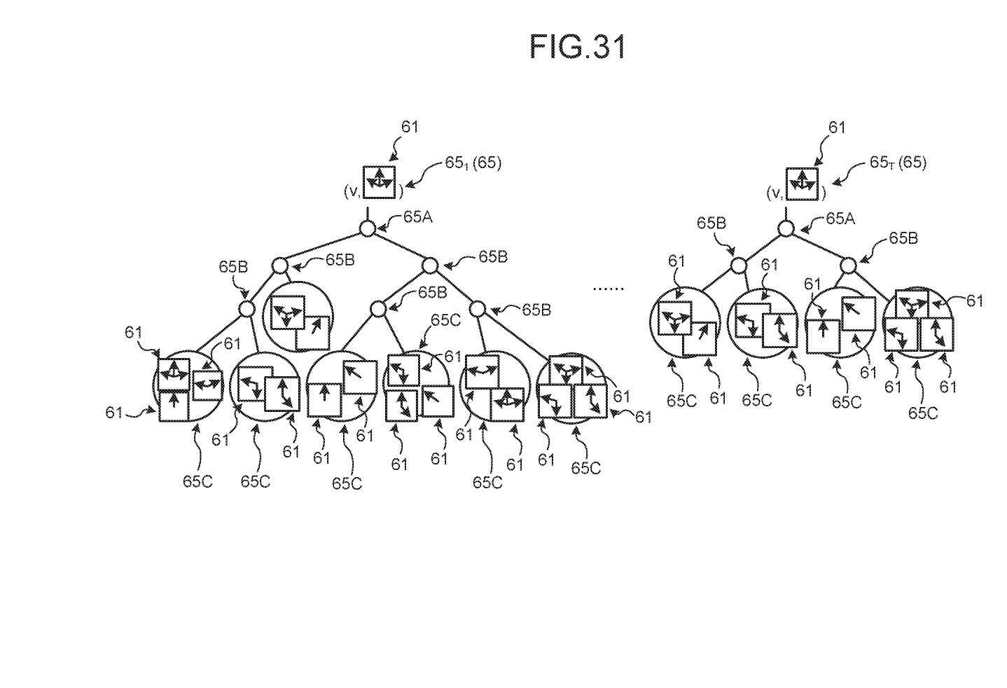

FIG. 31 is an explanatory diagram of a plurality of the learned random trees 65 (that is, a random forest). The respective random tree 65₁ to random tree 65_{T} have different division indexes for each node. Accordingly, for example, even when all the feature amounts v with the labels 61 allocated to the root nodes 65A are the same, the random tree 65₁ and the random tree 65_{T} might have the different feature amounts v with labels that belong to the leaf nodes 65C. The example illustrated in FIG. 31 illustrates the label 61 alone in the leaf node 65C. In practice, the feature amounts v with the labels 61 belong to the respective leaf nodes 65C.

Referring back to FIG. 27, the first predicting unit 54D predicts a representative label for each cluster divided by the learning unit 54C during learning. The first predicting unit 54D predicts the representative label from the label(s) 61 given to one or a plurality of the feature amounts v that belong to the cluster.

As described above, in this embodiment, the cluster means the leaf node 65C that is the node at the end of the random tree 65. Accordingly, the first predicting unit 54D predicts the representative label of each of the respective leaf nodes 65C from the labels 61 given to the respective feature amounts v that belong to the leaf node 65C.

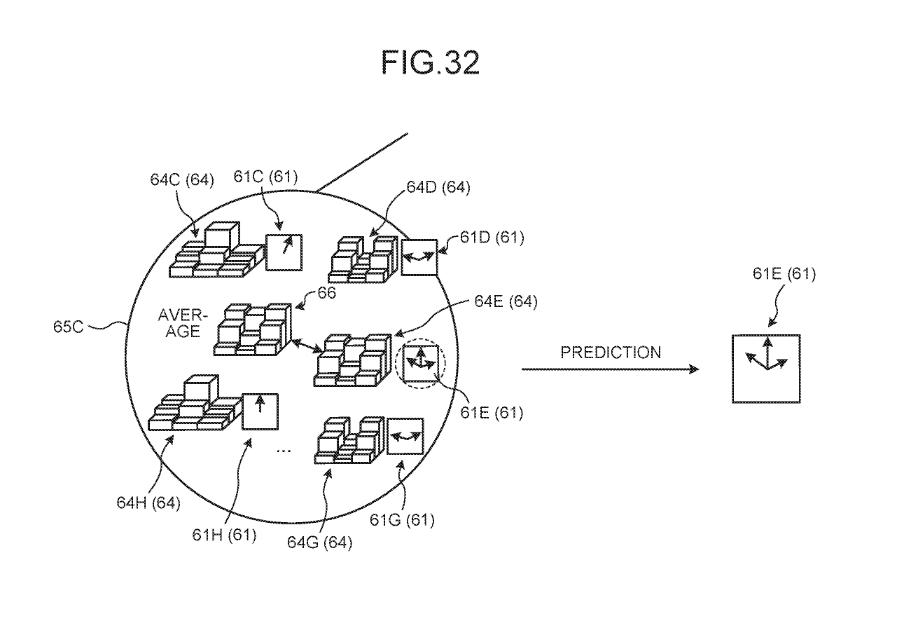

FIG. 32 is a diagram for explaining prediction of the representative label. In FIG. 32, a description is given of one leaf node 65C as an example. Firstly, the first predicting unit 54D reads the labels 61 given to all the respective feature amounts v that belong to the leaf node 65C. In the example illustrated in FIG. 32, the first predicting unit 54D reads labels 61C, 61D, 61E, 61G, and 61H. Subsequently, the first predicting unit 54D calculates an average histogram 66 that is the average of the voting histograms 64 (64C, 64D, 64E, 64G, and 64H) corresponding to these respective labels 61C, 61D, 61E, 61G, and 61H.

Subsequently, the first predicting unit 54D selects the voting histogram 64 close to the average histogram 66 among the plurality of these voting histograms 64 (64C, 64D, 64E, 64G, and 64H) that belong to the leaf node 65C. The first predicting unit 54D is preferred to select the voting histogram 64 closest to the average histogram 66 among the plurality of the voting histograms 64 (64C, 64D, 64E, 64G, and 64H) that belong to the leaf node 65C. In the example illustrated in FIG. 32, the first predicting unit 54D selects the voting histogram 64E closest to the average histogram 66. Then, the first predicting unit 54D predicts the label 61E that is the label 61 corresponding to this voting histogram 64E as the representative label of the leaf node 65C.

The first predicting unit 54D performs similar processing on all the leaf nodes 65C in all the random trees 65 learned by the learning unit 54C to predict the representative labels of the respective leaf nodes 65C.

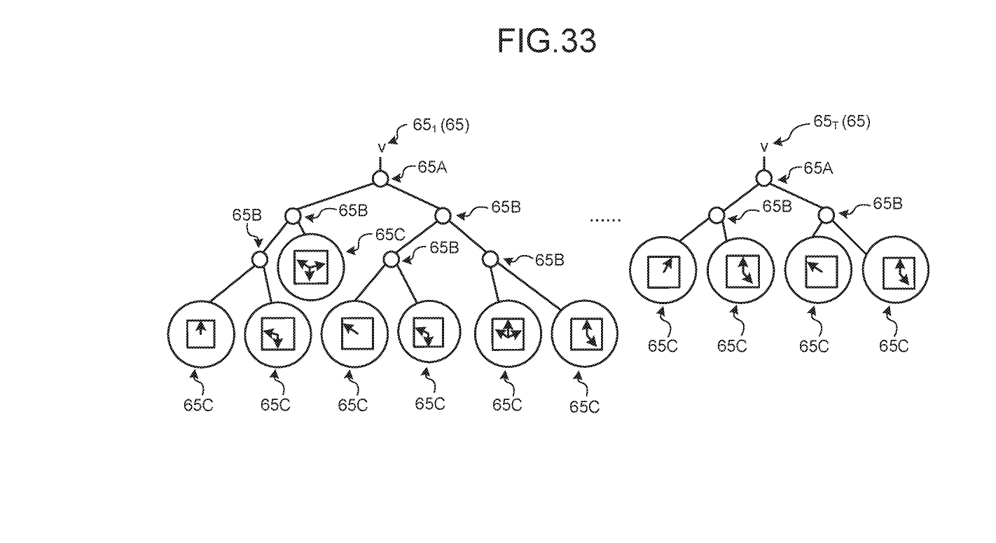

FIG. 33 is an explanatory diagram of the random trees 65 after the representative labels are predicted.

As illustrated in FIG. 33, the first predicting unit 54D predicts the representative label for each leaf node 65C so as to predict the representative labels of all the leaf nodes 65C for each random tree 65 for all the respective random trees 65 (the random trees 65₁ to 65_{T}) included in the random forest learned by the learning unit 54C.

As described above, the second calculator 54 calculates the regression models and the representative labels.

Referring back to FIG. 24, the second predicting unit 55 acquires the random trees 65, which are calculated as the regression models by the second calculator 54, and representative labels of the leaf nodes 65C. The second predicting unit 55 assigns the feature amounts calculated from the partial images to the variables of the random trees 65 acquired by the second calculator 54. As a result, the second predicting unit 55 predicts the representative labels corresponding to the respective partial images.

When the second calculator 54 acquires only a single random tree 65, the second predicting unit 55 predicts a single representative label for each partial image using the random tree 65. When the second calculator 54 acquires the multiple random trees 65 (i.e., random forest), the second predicting unit 55 obtains, for each partial image, the multiple representative labels corresponding to the random. trees 65, and predicts one of the representative labels as the representative label used for density measurement.

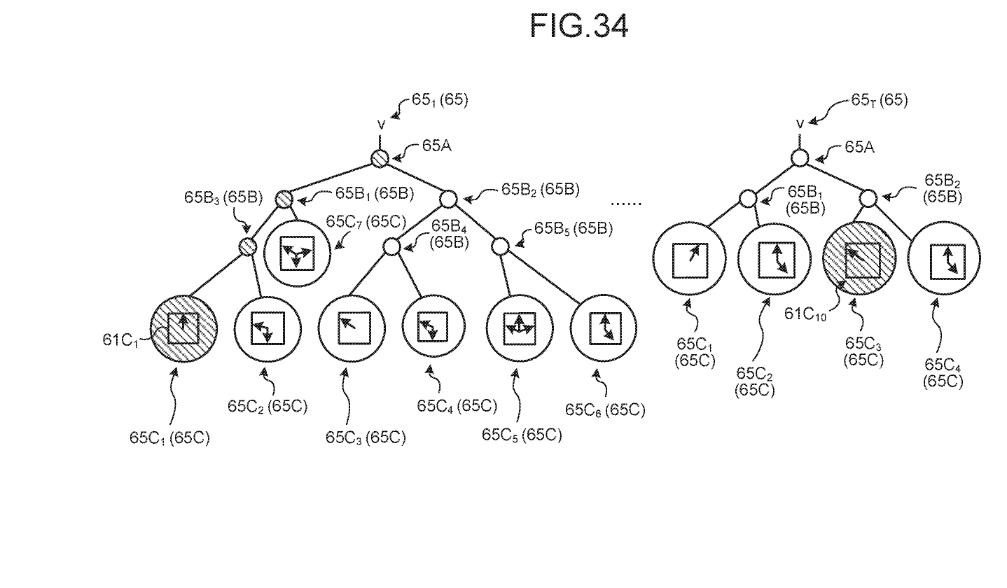

FIG. 34 is a diagram for explaining prediction of the representative labels performed by the second predicting unit 55. Assume that the random trees 65 acquired by the second calculator 54 and the representative labels are the random. trees 65 (the random trees 65₁ to 65_{T}) and the representative labels illustrated in FIG. 34, respectively.

In this case, the second predicting unit 55 assigns the feature amount of the partial image to each of the root nodes 65A of the respective random trees 65 (the random trees 65₁ to 65_{T}) included in the random forest. Then, the second predicting unit 55 goes down the tree structure from the root node 65A via the child node 65B to the leaf node 65C in accordance with the division indexes determined for each node of the random trees 65 (the random trees 65₁ to 65_{T}). Then, the second predicting unit 55 reads the representative label that belongs to the destination leaf node 65C.

Accordingly, the second predicting unit 55 obtains a plurality of representative labels obtained for the respective random trees 65 (the random trees 65₁ to 65_{T}) as the representative label corresponding to the feature amount of one partial image.

For example, a feature amount v1 of a certain partial image is assumed to be assigned to the root node 65A as the variable of the random tree 65₁. Then, child nodes 65B₁ and 65B₃ among child nodes 65B₁ to 65B₅ are traced to reach the leaf node 65C₁ among leaf nodes 65C₁ to 65C₇. In this case, the representative label determined by the random tree 65₁ for this feature amount v1 is a label 61C₁.

Additionally, this feature amount v1 is assumed to be assigned to the root node 65A as the variable of the random tree 65_{T}. Then, a child node 65B₂ among child nodes 65B₁ to 65B₂ is traced to reach the leaf node 65C₃ among leaf nodes 65C₁ to 65C₄. In this case, the representative label determined by the random tree 65_{T} for this feature amount v1 is a label 61C₁₀.

Subsequently, the second predicting unit 55 predicts one of the representative labels obtained for all the respective random trees 65 (the random trees 65₁ to 65_{T}) as the representative label used for density measurement. The second predicting unit 55 predicts the representative label for density measurement similarly to the first predicting unit 54D.

That is, the second predicting unit 55 calculates the average histogram of the voting histograms 64 corresponding to the representative labels obtained for all the random trees 65 (the random trees 65₁ to 65_{T}). Then, the second predicting unit 55 predicts the representative label corresponding to the voting histogram 64 closest to this average histogram among the plurality of the representative labels for all the random trees 65 (the random tree 65₁ to 65_{T}) as the representative label used for density measurement.

Referring back to FIG. 24, the density calculator 56 calculates the average density of the objects included in the correction image 39. The density calculator 56 calculates the density distribution of the objects in each of the plurality of partial images based on the relative positions of the objects represented by the representative labels corresponding to the respective second partial images predicted by the second predicting unit 55.

The density calculator 56 includes a third calculator 56A, a fourth calculator 56B, and a fifth calculator 56C.

The third calculator 56A calculates the density distribution of the objects in each of the plurality of the partial images based on the relative positions of the objects represented by the representative labels corresponding to the respective plurality of the partial images. The third calculator 56A preliminarily stores the first position used in the second calculator 54. The representative label is the above-described representative label used for density measurement.

For example, the third calculator 56A uses a probability density function N( ) of the normal distribution to calculate a density distribution Di(x) of the objects in the partial image.

Di(x)=ΣN(x; lj, σ) (7)

In the formula (7), x denotes any position in the partial image. In the formula (7), lj denotes a predicted relative position of the object. In the formula (7), σ denotes dispersion.

The fourth calculator 56B arranges, at the position corresponding to each of the plurality of the partial images in the correction image 39, the density distribution of the partial image. Arranging the density distribution means pasting, to the position corresponding to each of the plurality of the partial images in the correction image 39, the density distribution of the corresponding partial image.

Here, the plurality of the partial images extracted from the correction image 39 might at least partially overlap with one another. Accordingly, when the density distribution of the partial image extracted from the correction image 39 is arranged in the correction image 39, at least a part of the density distributions corresponding to the respective partial images might overlap with one another.

The fifth calculator 56C calculates a first average of the densities of the objects for each pixel included in the correction image 39 in accordance with the frequency of overlap of the density distributions in the correction image 39. The fifth calculator 56C calculates, for each region P used by the controller 12, the average of the densities of the class of target objects for provisional density calculation. The fifth calculator 56C calculates the calculation result as the provisional density of the class of target objects for provisional density calculation, which are captured in the region P in the image 30 and serve as the provisional density calculation targets by the fourth. calculation unit 50A. When the region P is equivalent to a single pixel, the fifth calculator 56C may calculate the first average calculated for each pixel as the provisional density of the class of target objects for provisional density calculation in each region P serving as the pixel.

In the fourth calculation unit 50A, each object class captured in the image 30 is subjected to the processing described above (i.e., the provisional density calculation processing) performed by the preprocessing unit 51, the extraction unit 52, the first calculator 53, the second calculator 54, the second predicting unit 55, and the density calculator 56.

As a result the fourth calculation unit 50A calculates the provisional density of each object class captured in the region P of image 30.

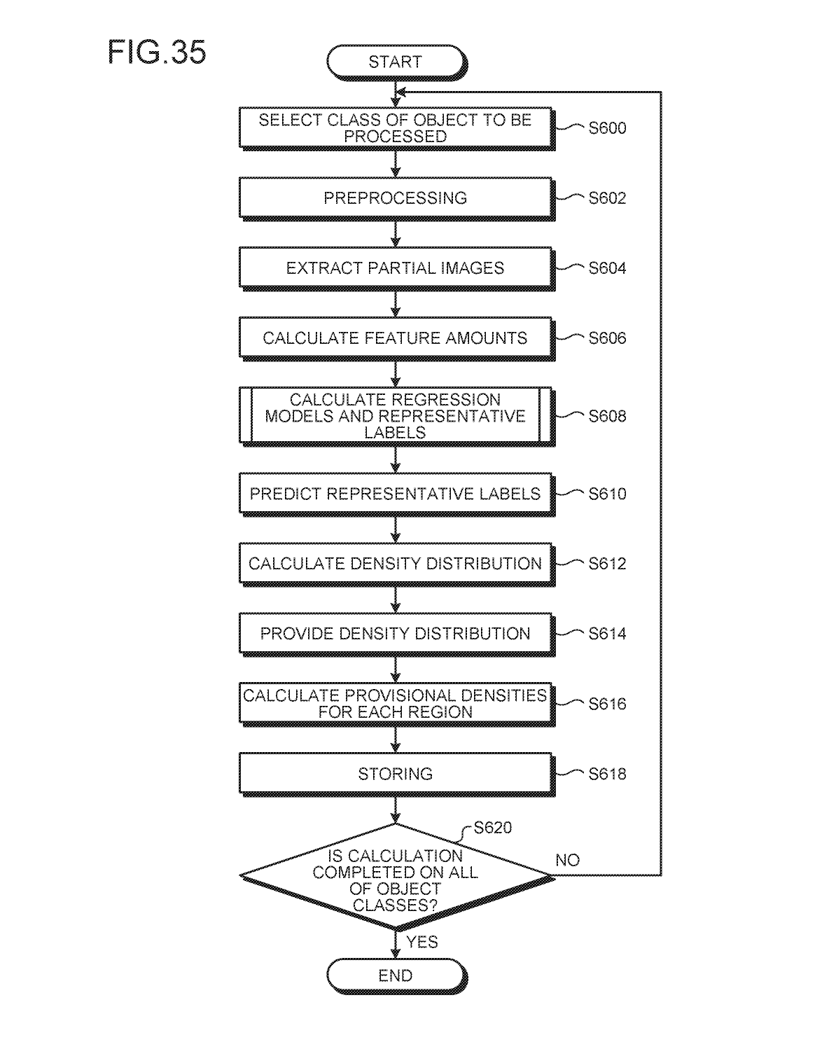

The following describes a procedure of the provisional density calculation processing performed by the fourth calculation unit 50A. FIG. 35 is a flowchart illustrating the procedure of the provisional density calculation processing performed by the fourth calculation unit 50A.

The fourth calculation unit 50A selects one object class that is not vet subjected to the provisional density calculation processing out of the objects of a plurality of classes captured in the image 30 (step S600).

The fourth calculation unit 50A performs the processing from step S602 to step S618 on the object class selected at step S600.

Specifically, the preprocessing unit 51 determines the object class selected at step S600 as the calculation target and performs the preprocessing on the image 30 acquired by the first acquisition unit 12A (refer to FIG. 1) (step S602). The preprocessing unit 51 performs the reduction processing to reduce the size of the object/objects of the class/classes other than the class of the target object/objects for calculation in the image 30 or the correction processing to correct the color/colors of the object class/classes other than the class of the target object/objects for calculation to the background color in the image 30, and produces the correction image 39.

The extraction unit 52 extracts a plurality of partial images from the correction image 39 produced at step S602 (step S604). The first calculator 53 calculates the feature amount of each partial image (step S606).

The second calculator 54 calculates the random trees 65 as the regression models and the representative labels (step S608), which is described later in detail.

The second predicting unit 55 assigns the feature amounts calculated from the partial images to the variables of the random trees 65 acquired by the second calculator 54. As a result, the second predicting unit 55 predicts the representative label corresponding to each partial image (step S610).

The third calculator 56A calculates the density distribution of the objects in each partial image on the basis of the relative positions of the objects indicated by the representative labels (step S612).

The fourth calculator 56B provides the density distribution of the corresponding partial image to the position corresponding to each of the partial images in the correction image 39 (step S614). The fifth calculator 56C calculates, for each region P in the correction image 39, the provisional densities of the object classes captured in the region P in accordance with the frequency of overlap of the density distributions in the correction image 39 (step S616).

The fifth calculator 56C stores the provisional densities of the object classes captured in each region P calculated at step S616 in the storage 14 (step S618).

The fourth calculation unit 50A determines whether the provisional density calculation is completed on all of the object classes captured in the image 30 acquired by the first acquisition unit 12A (step S620). At step S620, the determination is made by determining whether the processing from step S600 to step S618 is performed on all of the object classes captured in the image 30 acquired by the first acquisition unit 12A.

If the negative determination is made at step S620 (No at step S620), the processing returns to step S600. If the positive determination is made at step S620 (Yes at step S620), this routine ends.

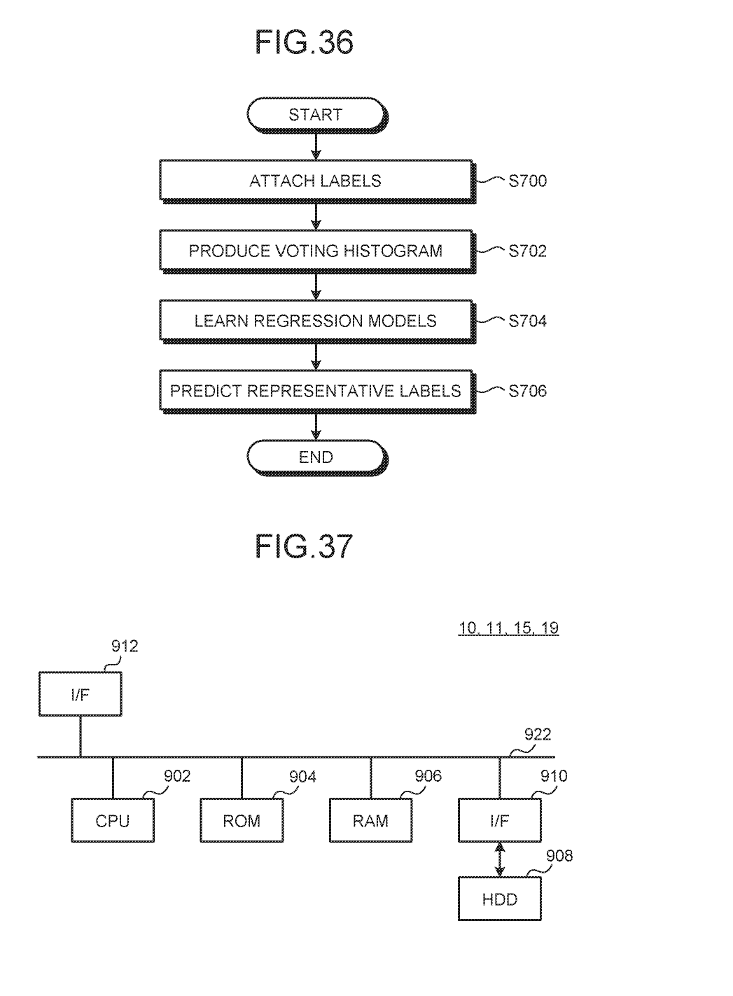

The following describes the calculation processing performed by the second calculator 54 at step S608 in FIG. 35. FIG. 36 is a flowchart illustrating a procedure of the calculation processing performed by the second calculator 54.

The searching unit 54A of the second calculator 54 attaches a label to the feature amount of each of the partial images 60 calculated at step S606 (refer to FIG. 35) (step S700). The voting unit 54B calculates the histogram 62 from the labels 61 and produces the voting histogram 64 by voting the histogram 62 into the parameter space 63 (step S702).

The learning unit 54C learns the regression models that represent the relation between the feature amounts of the partial images 60 and the relative positions of the objects captured in the partial images 60 (step S704). In the embodiment, the learning unit 54C learns the random trees 65 as the regression models, as described above.

The first predicting unit 54D predicts the representative label for each cluster (each leaf node 65C) obtained by being divided by the learning unit 54C during the learning (step S706).

The second calculator 54 outputs the random trees 65 learned as regression models and the representative labels of the clusters (the leaf nodes 65C) to the second predicting unit 55. Then, this routine ends.

As described above, the searching unit 54A of the second calculator 54 in the embodiment searches for the objects captured in each of the partial images 60 extracted from the image 30 (or the correction image 39). The searching unit 54A generates, as the label, a vector representing the relative positions between the predetermined first position in each partial image 60 and all of the objects captured in the partial image 60. The learning unit 54C allocates the labeled feature amount to each node to determine a division index of each node, thereby learning the regression models. The first predicting unit 54D predicts the representative label for each leaf node 65C of the regression models.

A label represents a vector that indicates the relative positions of the objects, and has a small data size. As a result, the volume of data required for forming the regression models can be reduced. The density calculation using the regression models in the embodiment allows the image processing apparatus 10 to calculate the density of the objects with low memory capacity in addition to the effects of the embodiments.

The fourth calculation unit 50A learns the regression models without directly detecting the objects from the correction image 39. The fourth calculation unit 50A of the image processing apparatus 10 in the embodiment can learn the regression models that allow performing the density calculation with high accuracy without reduction in measurement accuracy even when the objects are small and overlap with one another in the correction image 39.

The fourth calculation unit 50A of the image processing apparatus 10 in the embodiment performs the processing described in the embodiment, thereby making it possible to provide data (the regression models) for performing the density calculation with high accuracy and low memory capacity in addition to the effects of the first embodiment.

The image processing apparatuses 10, 11, 15, and 19 in the embodiments and the modifications are applicable to various apparatuses that detect the attention regions Q using the densities of the objects captured in the image 30. For example, the image processing apparatuses 10, 11, 15, and 19 in the embodiments and the modifications are applicable to monitoring apparatuses that monitor specific monitoring regions. In this case, the imager 23 may be provided at a position where the monitoring target regions can be imaged. The attention region Q may be detected using the image 30 of the monitoring target taken by the imager 23.

Specifically, the image processing apparatuses 10, 11, 15, and 19 in the embodiments and the modifications are also applicable to a monitoring system for smart community, a plant monitoring system, and an abnormal portion detection system for medical use. The applicable range is not limited to any specific range.

FIG. 37 is a block diagram illustrating an exemplary hardware structure of the image processing apparatuses 10, 11, 15, and 19 in the embodiments and the modifications. The image processing apparatuses 10, 11, 15, and 19 in the embodiments and the modifications each have a hardware structure using a typical computer. The hardware structure includes a CPU 902, a RAM 906, a ROM 904 that stores therein a computer program, for example, an HDD 908, an interface (I/F) 910 that is an interface with the HDD 908, an I/F 912 that is an interface for image input, and a bus 922. The CPU 902, the ROM 904, the RAM 906, the I/F 910, and the I/F 912 are coupled to one another via the bus 922.

In the image processing apparatuses 10, 11, 15, and 19 in the embodiments and the modifications, the CPU 902 reads the computer program from the ROM 904 to the RAM 906 and executes the computer program, so that the respective components are implemented in the computer.

The computer program to achieve the various types of processing performed by each of the image processing apparatuses 10, 11, 15, and 19 in the embodiments may be stored in the HDD 908. The computer program to achieve the various types of processing performed by the image processing apparatus 10 in the embodiment may previously be embedded and provided in the ROM 904.

The computer program to achieve the processing performed by each of the image processing apparatuses 10, 11, 15, and 19 in the embodiments can be stored and provided as a computer program product in a computer-readable storage medium such as a compact disc read only memory (CD-ROM), a compact disc recordable (CD-R), a memory card, a digital versatile disc (DVD), a flexible disk (FD) in an installable or executable file.

The computer program to achieve the processing performed by each of the image processing apparatuses 10, 11, 15, and 19 in the embodiments may be stored in a computer connected So a network such as the Internet, and provided by being downloaded via the network. The computer program to achieve the processing performed by each of the image processing apparatuses 10, 11, 15, and 19 in the embodiments may be provided or distributed via a network such as the Internet.

For example, the steps in the flowcharts explained in the embodiments may be executed in different orders, some of the steps may be executed simultaneously, or may be executed in different orders in each of implementations, as long as the implementations are not against the nature of the steps.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising
a hardware processor configured to:
acquire an image;
calculate a density of an object captured in a region obtained by dividing the image;
calculate a first density relative value of the region to a surrounding region which is surrounding the region; and
detect an attention region out of the regions included in the image according to the first density relative value.

2. The apparatus according to claim 1, wherein the hardware processor detects the attention region when the region has the first density relative value larger than a first threshold or smaller than the first threshold.

3. The apparatus according to claim 1, wherein the hardware processor calculates the first density relative value of the region by sequentially setting each of the regions as a first region that is a calculation target of the first density relative value, and calculating the first density relative value of the density in the first region with respect to the density in the surrounding region that includes a plurality of second regions arranged around the first region, the second regions being the regions other than the first region.

4. The apparatus according to claim 3, wherein the hardware processor calculates the first density relative value by calculating, as the density in the surrounding region, an average of the respective densities in the second regions included in the surrounding region.

5. The apparatus according to claim 3, wherein the hardware processor calculates the first density relative value by calculating, as the density in the surrounding region, an average of multiplication values obtained by multiplying the respective densities in the second regions included in the surrounding region by first weight values m, the second regions disposed closer to the first region being multiplied. by the larger first weight values m.

6. The apparatus according to claim. 3, wherein the hardware processor calculates the first density relative value by calculating, as the density in the surrounding region, an average of multiplication values obtained by multiplying the respective densities in the second regions included in the surrounding region by second weight values n, the second regions including the respective objects having a smaller distance from the first region being multiplied by the larger second weight values n.

7. The apparatus according to claim 1, wherein the first hardware processor is further configured to:
calculate a density of the object captured in each of the regions obtained by dividing the image;
identify one of the regions in the image where the density is larger than a second threshold; and
correct the density in the identified region to a sum of the density in the identified region and a multiplication value, the multiplication value being obtained by multiplying the respective densities in the regions included in the surrounding region of the identified region by third weight values p, p being a value larger than zero and smaller than one.

8. The apparatus according to claim 2, wherein the hardware processor is further configured to:
calculate, for each of third regions included in predicted density information in which predicted densities in the respective regions included in the image are specified, a third density relative value of the third region with respect to the density in a third surrounding region of the third region, the third regions corresponding to the respective regions; and
detect, as the attention region, the region having the first density relative value larger than the first threshold or smaller than the first threshold, out of the regions included in the image, the first threshold being the third density relative value of the third region in the predicted density information, the third region corresponding to the region.

9. The apparatus according to claim 8, further comprising storage, wherein the hardware processor is further configured to:
acquire an imaging environment of the image; and
calculate the third density relative value for each of the third regions in the predicted density information corresponding to the acquired imaging environment.

10. The apparatus according to claim 2, wherein
the hardware processor
calculates, as the first density relative value, a group of second density relative values of the density in the first region with respect to the respective densities in the second regions that are included in the surrounding region of the first region and adjacent to the first region, and
sets boundary between the first region and the second regions that are used for the calculation of the second density relative value when the second density relative value is larger than or smaller than the first threshold, and
detects, as the attention region, the regions inside or outside a virtual line indicated by the continuous boundary, out of the regions included in the image.

11. The apparatus according to claim 1, further comprising a display controller configured to display the detected attention region on a display.

12. The apparatus according to claim 11, wherein the display controller controls the display to display a display image that displays the attention region in the image in a display form different from the display form of an external region of the attention region.

13. The apparatus according to claim 11, wherein the display controller identifies, as an attention neighborhood region, the region from which an object possibly enters the attention region, out of the regions included in the image, and displays the attention region and the attention neighborhood region on the display.

14. The apparatus according to claim 11, wherein
the hardware processor
acquires a plurality of the images captured in time series,
calculates, for each of the images and for each of the regions obtained by dividing the image, the density of the object captured in the region,
calculates, for each of the images, the first density relative value of each region included in the image,
detects the attention region for each of the images, and
the display controller calculates an expansion speed or a moving speed of the attention region using the detected attention region of each of the images, and displays, on the display, the display image that indicates the attention region in the display form in accordance with the expansion speed or the moving speed of the attention region.

15. An image processing method performed by an image processing apparatus, comprising:
acquiring an image;
calculating a density of an object captured in a region obtained by dividing the image;
calculating a first density relative value of the region to a surrounding region which is surrounding the region; and
detecting an attention region out of the regions included in the image according to the first density relative value.
